(19) United States
(12) Patent Application Publication
(10) Pub. No.: US 2026/0197730 A1
(43) Pub. Date: Jul. 9, 2026

(54) USER EQUIPMENT INITIATED CELL SWITCH

(71) Applicant: Samsung Electronics Co., Ltd., Suwon-si (KR)

(72) Inventors: Emad Nader Farag, Flanders, NJ (US); Eko Onggosanusi, Coppell, TX (US); Shiyang Leng, Allen, TX (US)

(21) Appl. No.: 19/555,765

(22) Filed: Mar. 3, 2026

Related U.S. Application Data
(63) Continuation of application No. 18/335,677, filed on Jun. 15, 2023.
(60) Provisional application No. 63/356,815, filed on Jun. 29, 2022.

(51) Int. Cl. H04W 36/00; H04W 36/08

(52) U.S. Cl. CPC H04W 36/0085; H04W 36/0058; H04W 36/0072; H04W 36/085

(57) ABSTRACT

Apparatuses and methods for a UE initiated cell switch. A method for operating a user equipment (UE) includes receiving configuration information for reference signals associated with measurement of one or more candidate cells, receiving configuration information for transmission configuration indicator (TCI) state lists associated with the one or more candidate cells, performing measurement on the reference signals, determining, based on the measurement, a measurement report, and transmitting the measurement report.

### CROSS-REFERENCE TO RELATED APPLICATION(S) AND CLAIM OF PRIORITY

This application is a continuation of U.S. application Ser. No. 18/335,677 filed on Jun. 15, 2023, which claims priority under 35 U.S.C. § 119(e) to U.S. Provisional Patent Application No. 63/356,815 filed on Jun. 29, 2022. The above-identified patent documents are hereby incorporated by reference in their entireties.

### TECHNICAL FIELD

This disclosure relates generally to wireless communication systems and, more specifically, to a user equipment (UE) initiated cell switch.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure relates to apparatuses and methods for a UE initiated cell switch.

In one embodiment, a user equipment (UE) is provided. The UE includes a transceiver configured to receive configuration information for reference signals associated with measurement of one or more candidate cells, and receive configuration information for transmission configuration indicator (TCI) state lists associated with the one or more candidate cells. The UE further includes a processor operably coupled to the transceiver, the processor configured to perform measurement on the reference signals, and determine, based on the measurement, a measurement report. The transceiver is further configured to transmit the measurement report. The measurement report includes L×M measurements. L is a number of cells included in the measurement report, and M is a number of measurements reported for each cell of the number of cells in the measurement report. The measurement report includes reference signal ID and a corresponding measured L1-reference signal received power (L1-RSRP). The measurement report is included in uplink control information (UCI), transmitted on a physical uplink control channel (PUCCH) or a physical uplink shared channel (PUSCH).

In another embodiment, a base station (BS) is provided. The BS includes a transceiver configured to transmit configuration information for reference signals associated with measurement of one or more candidate cells, transmit configuration information for TCI state lists associated with the one or more candidate cells, and receive a measurement report. The measurement report includes L×M measurements. L is a number of cells included in the measurement report, and M is a number of measurements reported for each cell of the number of cells in the measurement report. The measurement report includes reference signal ID and a corresponding measured L1-RSRP. The measurement report is included in UCI, received on a PUCCH or a PUSCH.

In yet another embodiment, a method of operating a UE is provided. The method includes receiving configuration information for reference signals associated with measurement of one or more candidate cells, receiving configuration information for TCI state lists associated with the one or more candidate cells, performing measurement on the reference signals, determining, based on the measurement, a measurement report, and transmitting the measurement report. The measurement report includes L×M measurements. L is a number of cells included in the measurement report, and M is a number of measurements reported for each cell of the number of cells in the measurement report. The measurement report includes reference signal ID and a corresponding measured L1-RSRP. The measurement report is included in UCI, transmitted on a PUCCH or a PUSCH.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure.

FIG. 3A illustrates an example gNodeB (gNB) according to embodiments of the present disclosure;

FIG. 3B illustrates an example UE according to embodiments of the present disclosure;

FIG. 4A illustrates an example beam in a wireless system according to the present disclosure;

FIG. 4B illustrates an example of multiple beams in a wireless system according to the present disclosure;

FIG. 5 illustrates example antenna blocks or arrays according to embodiments of the present disclosure;

FIG. 6 illustrates an example of a beam change from the TRP of a serving cell, to a TRP of a cell with PCI different from that of the serving cell according to the present disclosure;

FIG. 7 illustrates an example of UE configuration according to the present disclosure;

FIG. 8 illustrates an example method of handover based on TCI state indication according to the present disclosure;

FIG. 9 illustrates an example method of handover to a target (or candidate) cell after a beam application delay according to the present disclosure;

FIG. 10 illustrates an example method of handover based on TCI state indication according to the present disclosure;

FIG. 11 illustrates an example method handover to a target (or candidate) cell after a cell switch application delay according to the present disclosure;

FIG. 12 illustrates an example method of handover based on UE initiation according to the present disclosure;

FIG. 13 illustrates an example method of handover to a target (or candidate) cell after a cell switch time according to the present disclosure;

FIG. 14 illustrates an example method of handover based on UE initiation according to the present disclosure;

FIG. 15 illustrates an example method of handover based on UE initiation. according to the present disclosure;

FIG. 16 illustrates an example method of handover based on UE initiation according to the present disclosure;

FIG. 17 illustrates an example method for a handover to the target (or candidate) cell after a cell switch time according to the present disclosure; and

FIG. 18 illustrates an example method of a UE initiated cell switch according to embodiments of the present disclosure.

### DETAILED DESCRIPTION

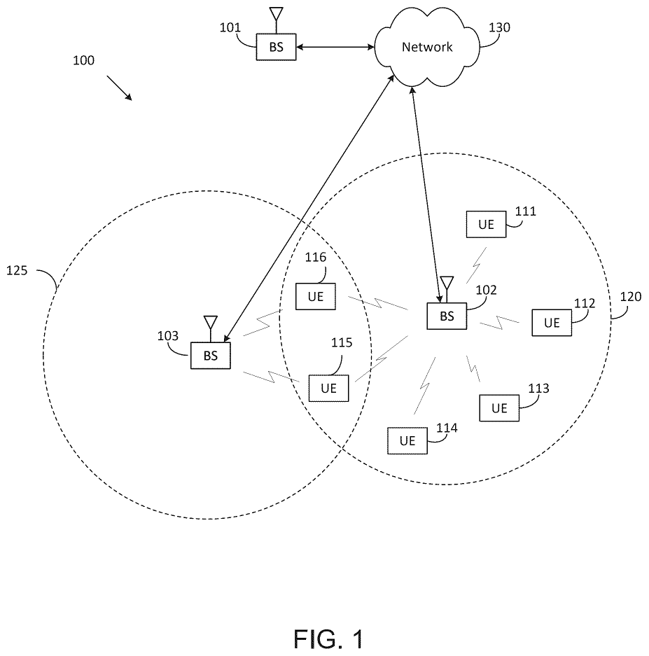

FIGS. 1 through 18, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

The following documents and standards descriptions are hereby incorporated into the present disclosure as if fully set forth herein: 3GPP TS 38.211 v17.2.0, “NR; Physical channels and modulation”; 3GPP TS 38.212 v17.2.0, “NR; Multiplexing and Channel coding”; 3GPP TS 38.213 v17.2.0, “NR; Physical Layer Procedures for Control”; 3GPP TS 38.214 v17.1.0, “NR; Physical Layer Procedures for Data”; 3GPP TS 38.321 v17.1.0, “NR; Medium Access Control (MAC) protocol specification”; 3GPP TS 38.331 v17.1.0, “NR; Radio Resource Control (RRC) Protocol Specification”, and 3GPP RP-213565, “Further NR Mobility Enhancements.”

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for a UE initiated cell switch. In certain embodiments, one or more of the gNBs 101-103 includes circuitry, programing, or a combination thereof, to support a UE initiated cell switch in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

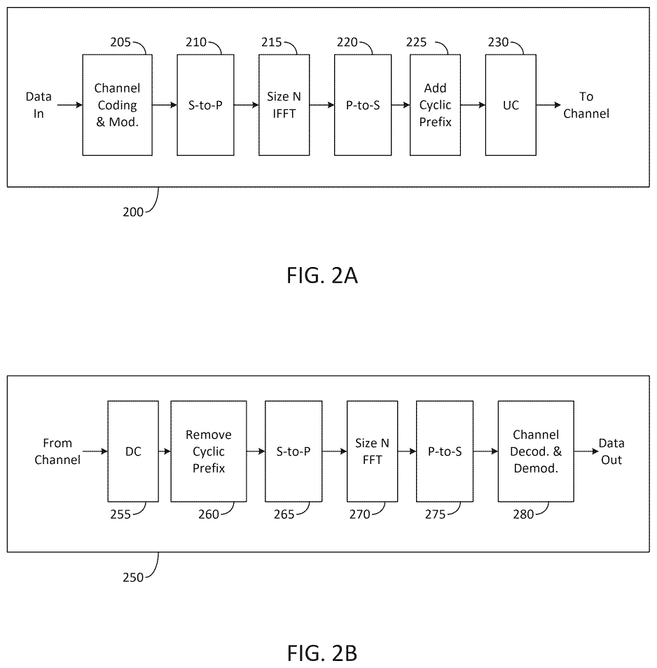

FIGS. 2A and 2B illustrate example wireless transmit and receive paths according to embodiments of the present disclosure. In the following description, a transmit path 200 may be described as being implemented in an gNB (such as gNB 102), while a receive path 250 may be described as being implemented in a UE (such as UE 116). However, it will be understood that the receive path 250 can be implemented in an gNB and that the transmit path 200 can be implemented in a UE. In some embodiments, the receive path 250 is configured to support a UE initiated cell switch in a wireless communication system as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

Although FIGS. 2A and 2B illustrate one example of wireless transmit and receive paths, various changes may be made to FIGS. 2A and 2B. For example, the blocks could be arranged in a different order or arranged to operate concurrently, additional blocks may be added, some blocks may be omitted, etc.

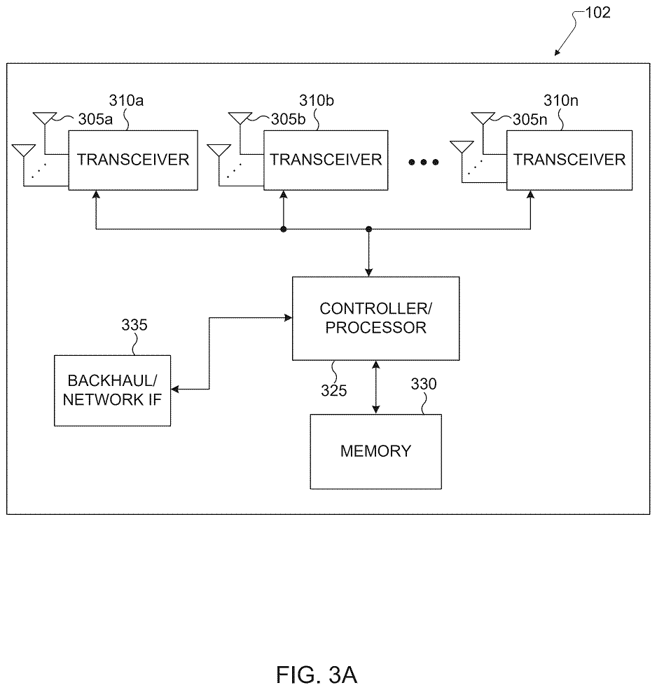

FIG. 3A illustrates an example gNB 102 according to embodiments of the present disclosure. The embodiment of the gNB 102 illustrated in FIG. 3A is for illustration only, and the gNBs 101 and 103 of FIG. 1 could have the same or similar configuration. However, gNBs come in a wide variety of configurations, and FIG. 3A does not limit the scope of this disclosure to any particular implementation of a gNB.

As shown in FIG. 3A, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 310a-310n and/or controller/processor 325 receives analog or digital data (such as voice data, web data, e-mail, or interactive video game data) from the controller/processor 325. The TX processing circuitry encodes, multiplexes, and/or digitizes the outgoing baseband data to generate processed baseband or IF signals. The transceivers 310a-310n up-converts the baseband or IF signals to RF signals that are transmitted via the antennas 305a-305n.

The controller/processor 325 can include one or more processors or other processing devices that control the overall operation of the gNB 102. For example, the controller/processor 325 could control the reception of UL channels or signals and the transmission of DL channels or signals by the transceivers 310a-310n in accordance with well-known principles. The controller/processor 325 could support additional functions as well, such as more advanced wireless communication functions. For instance, the controller/processor 325 could support beam forming or directional routing operations in which outgoing/incoming signals from/to multiple antennas 305a-305n are weighted differently to effectively steer the outgoing signals in a desired direction. Any of a wide variety of other functions could be supported in the gNB 102 by the controller/processor 325.

The controller/processor 325 is also capable of executing programs and other processes resident in the memory 330, such as an OS and, for example, processes to support a UE initiated cell switch as discussed in greater detail below. The controller/processor 325 can move data into or out of the memory 330 as required by an executing process.

The controller/processor 325 is also coupled to the backhaul or network interface 235. The backhaul or network interface 335 allows the gNB 102 to communicate with other devices or systems over a backhaul connection or over a network. The interface 335 could support communications over any suitable wired or wireless connection(s). For example, when the gNB 102 is implemented as part of a cellular communication system (such as one supporting 5G/NR, LTE, or LTE-A), the interface 335 could allow the gNB 102 to communicate with other gNBs over a wired or wireless backhaul connection. When the gNB 102 is implemented as an access point, the interface 335 could allow the gNB 102 to communicate over a wired or wireless local area network or over a wired or wireless connection to a larger network (such as the Internet). The interface 335 includes any suitable structure supporting communications over a wired or wireless connection, such as an Ethernet or transceiver.

The memory 330 is coupled to the controller/processor 325. Part of the memory 330 could include a RAM, and another part of the memory 330 could include a Flash memory or other ROM.

Although FIG. 3A illustrates one example of gNB 102, various changes may be made to FIG. 3A. For example, the gNB 102 could include any number of each component shown in FIG. 3A. Also, various components in FIG. 3A could be combined, further subdivided, or omitted and additional components could be added according to particular needs.

FIG. 3B illustrates an example UE 116 according to embodiments of the present disclosure. The embodiment of the UE 116 illustrated in FIG. 3B is for illustration only, and the UEs 111-115 of FIG. 1 could have the same or similar configuration. However, UEs come in a wide variety of configurations, and FIG. 3B does not limit the scope of this disclosure to any particular implementation of a UE.

As shown in FIG. 3B, the UE 116 includes antenna(s) 306, a transceiver(s) 311, and a microphone 320. The UE 116 also includes a speaker 331, a processor 340, an input/output (I/O) interface (IF) 345, an input 350, a display 355, and a memory 360. The memory 360 includes an operating system (OS) 361 and one or more applications 362.

The transceiver(s) 311 receives from the antenna 306, an incoming RF signal transmitted by a gNB of the network 100. The transceiver(s) 311 down-converts the incoming RF signal to generate an intermediate frequency (IF) or baseband signal. The IF or baseband signal is processed by RX processing circuitry in the transceiver(s) 311 and/or processor 340, which generates a processed baseband signal by filtering, decoding, and/or digitizing the baseband or IF signal. The RX processing circuitry sends the processed baseband signal to the speaker 331 (such as for voice data) or is processed by the processor 340 (such as for web browsing data).

TX processing circuitry in the transceiver(s) 311 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 311 up-converts the baseband or IF signal to an RF signal that is transmitted via the antenna(s) 306.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 311 in accordance with well-known principles. In some embodiments, the processor 340 includes at least one microprocessor or microcontroller.

The processor 340 is also capable of executing other processes and programs resident in the memory 360, for example, processes for a UE initiated cell switch as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3B illustrates one example of UE 116, various changes may be made to FIG. 3B. For example, various components in FIG. 3B could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 311 may include any number of transceivers and signal processing chains and may be connected to any number of antennas. Also, while FIG. 3B illustrates the UE 116 configured as a mobile telephone or smartphone, UEs could be configured to operate as other types of mobile or stationary devices.

In the present disclosure a beam may be determined by any of:
a transmission configuration indication (TCI) state that establishes a quasi co-location (QCL) relationship,
a spatial relation between a source reference signal (e.g., a synchronization signal block (SS/PBCH Block or SSB),
a channel state information reference signal (CSI-RS)) and a target reference signal,
a spatial relationship information that establishes an association to a source reference signal, such as an SSB, CSI-RS, or
a sounding reference signal (SRS). In either case, the ID of the source reference signal identifies the beam.

The TCI state and/or the spatial relationship reference RS can determine a spatial Rx filter for reception of downlink channels at the UE, or a spatial Tx filter for transmission of uplink channels from the UE. The TCI state and/or the spatial relation reference RS can determine a spatial Tx filter for transmission of downlink channels or signals from the gNB, or a spatial Rx filter for reception of uplink channels or signals at the gNB.

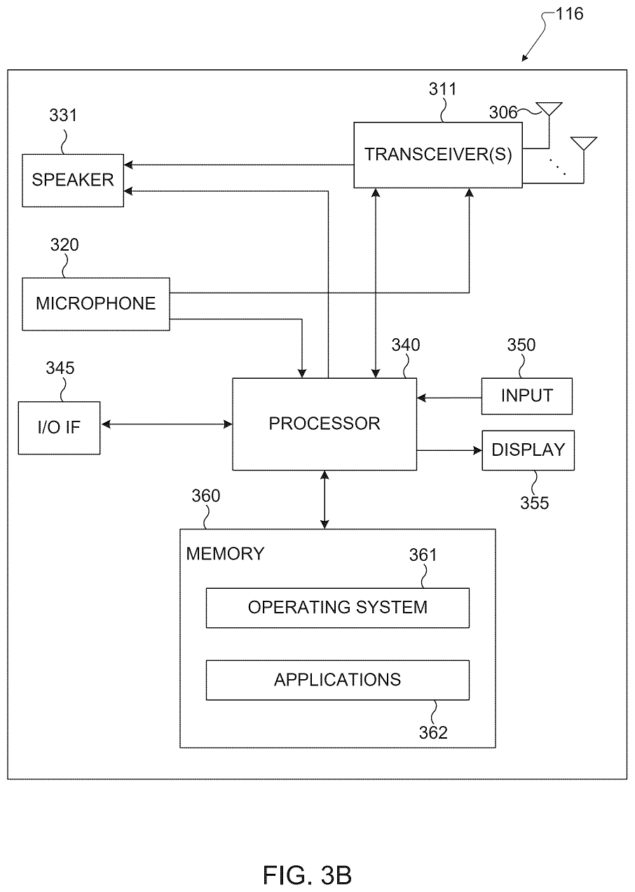

FIG. 4A illustrates an example beam in a wireless system according to the present disclosure. The embodiment of the beam illustrated in FIG. 4A is for illustration only. Other embodiments of the beam could be used without departing from the scope of this disclosure.

As illustrated in FIG. 4A, in a wireless system a beam (401), for a device (404), may be characterized by a beam direction (402) and a beam width (403). For example, a device (404) transmits radio frequency (RF) energy in a beam direction and within a beam width. A device (404) receives RF energy in a beam direction and within a beam width. As illustrated in FIG. 4A, a device at Point A (405) may receive from and transmit to device (404) as Point A is within a beam width and direction of a beam from device (404). As illustrated in FIG. 4A, a device at Point B (406) cannot receive from and transmit to device (404) as Point B is outside a beam width and direction of a beam from device (404). While FIG. 4A, for illustrative purposes, shows a beam in 2-dimensions (2D), it should be apparent to those skilled in the art, that a beam may be in 3-dimensions (3D), where the beam direction and beam width are defined in space. Although FIG. 4A illustrates one example of a wireless beam, various changes may be made to FIG. 4A. For example, the beam direction and the beam width may be changed.

FIG. 4B illustrates an example of multiple beams in a wireless system according to the present disclosure. The embodiment of the beams illustrated in FIG. 4B is for illustration only. Other embodiments of the beams could be used without departing from the scope of this disclosure.

As illustrated in FIG. 4B, in a wireless system, a device may transmit and/or receive on multiple beams. This is known as “multi-beam operation” and is illustrated in FIG. 4B. While FIG. 4B, for illustrative purposes, a beam is in 2D, it should be apparent to those skilled in the art, that a beam may be 3D, where a beam may be transmitted to or received from any direction in space.

Although FIG. 4B illustrates one example of a multiple beams in a wireless system, various changes may be made to FIG. 4B. For example, the number of beams, the beam directions, and the beam directions may be changed.

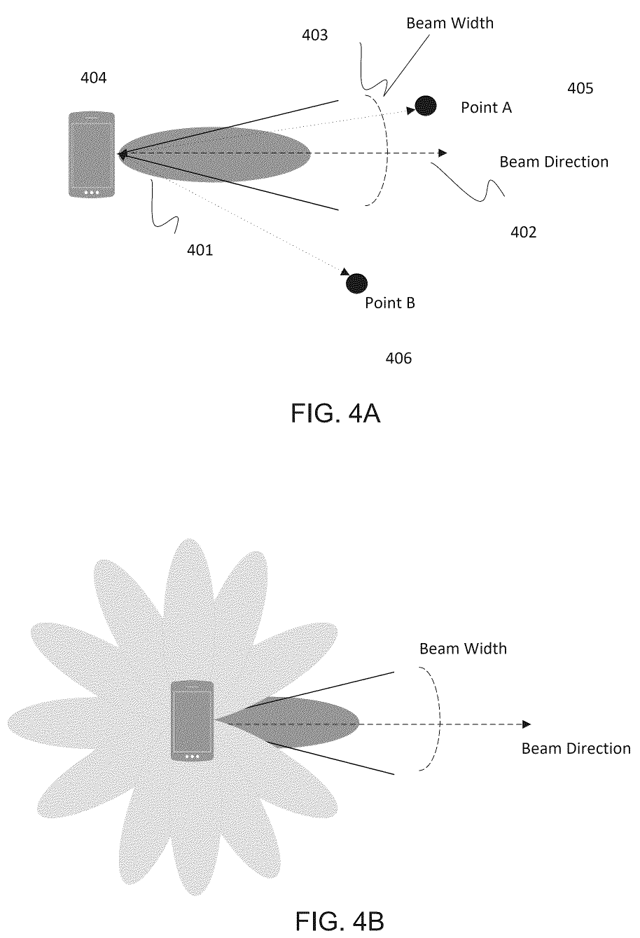

FIG. 5 illustrates example antenna blocks or arrays 500 according to embodiments of the present disclosure. The embodiment of the antenna blocks or arrays 500 illustrated in FIG. 5 is for illustration only. Different embodiments of antenna blocks or arrays 500 could be used without departing from the scope of this disclosure.

A unit for DL signaling or for UL signaling on a cell is referred to as a slot and may include one or more symbols. A bandwidth (BW) unit is referred to as a resource block (RB). One RB includes a number of sub-carriers (SCs). For example, a slot may have duration of one millisecond and an RB may have a bandwidth of 180 KHz and include 12 SCs with inter-SC spacing of 15 KHz. A slot may be either full DL slot, or full UL slot, or hybrid slot similar to a special subframe in time division duplex (TDD) systems.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH may be transmitted over a variable number of slot symbols including one slot symbol. A UE may be indicated a spatial setting for a PDCCH reception based on a configuration of a value for a transmission configuration indication state (TCI state) of a control resource set (CORESET) where the UE receives the PDCCH. The UE may be indicated by a spatial setting for a PDSCH reception based on a configuration by higher layers or based on activation or indication by MAC CE or based on an indication by a DCI format scheduling the PDSCH reception of a value for a TCI state. The gNB may configure the UE to receive signals on a cell within a DL bandwidth part (BWP) of the cell DL BW.

A gNB transmits one or more of multiple types of RS including channel state information RS (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process consists of NZP CSI-RS and CSI-IM resources. A UE may determine CSI-RS transmission parameters through DL control signaling or higher layer signaling, such as an RRC signaling from a gNB. Transmission instances of a CSI-RS may be indicated by DL control signaling or configured by higher layer signaling. A DMRS is transmitted only in the BW of a respective PDCCH or PDSCH and a UE may use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH may be transmitted over a variable number of slot symbols including one slot symbol. The gNB may configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, and CSI reports enabling a gNB to select appropriate parameters for PDSCH or PDCCH transmissions to a UE. HARQ-ACK information may be configured to be with a smaller granularity than per TB and may be per data code block (CB) or per group of data CBs where a data TB includes a number of data.

A CSI report from a UE may include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a multiple input multiple output (MIMO) transmission principle, and of a rank indicator (RI) indicating a transmission rank for a PDSCH. UL RS includes DMRS and SRS. DMRS is transmitted only in a BW of a respective PUSCH or PUCCH transmission. A gNB may use a DMRS to demodulate information in a respective PUSCH or PUCCH. SRS is transmitted by a UE to provide a gNB with an UL CSI and, for a TDD system, an SRS transmission may also provide a PMI for DL transmission. Additionally, in order to establish synchronization or an initial higher layer connection with a gNB, a UE may transmit a physical random-access channel (PRACH).

Rel-14 LTE and Rel-15 NR support up to 32 CSI-RS antenna ports which enable an eNB or a gNB to be equipped with a large number of antenna elements (such as 64 or 128). A plurality of antenna elements may then be mapped onto one CSI-RS port. For mmWave bands, although a number of antenna elements may be larger for a given form factor, a number of CSI-RS ports, that may correspond to the number of digitally precoded ports, may be limited due to hardware constraints (such as the feasibility to install a large number of ADCs/DACs at mmWave frequencies) as illustrated in FIG. 5. Then, one CSI-RS port may be mapped onto a large number of antenna elements that may be controlled by a bank of analog phase shifters 501. One CSI-RS port may then correspond to one sub-array which produces a narrow analog beam through analog beamforming 505. This analog beam may be configured to sweep across a wider range of angles (520) by varying the phase shifter bank across symbols or slots/subframes. The number of sub-arrays (equal to the number of RF chains) is same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding may be varied across frequency sub-bands or resource blocks. Receiver operation may be conceived analogously.

Since the above system utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL transmit (TX) beam (also termed “beam indication”), measuring at least one reference signal for calculating and performing beam reporting (also termed “beam measurement” and “beam reporting”, respectively), and receiving a DL or UL transmission via a selection of a corresponding receive (RX) beam.

The above system is also applicable to higher frequency bands such as >52.6 GHz. In this case, the system may employ only analog beams. Due to the O2 absorption loss around 60 GHz frequency (~10 dB additional loss per 100 m distance), a larger number and narrower analog beams (hence larger number of radiators in the array) are needed to compensate for the additional path loss.

Rel-17 introduced the unified TCI framework, where a unified or master or main or indicated TCI state is signaled or indicated to the UE. The unified or master or main or indicated TCI state may be one of:
1. In case of joint TCI state indication, wherein a same beam is used for DL and UL channels, a joint TCI state that may be used at least for UE-dedicated DL channels and UE-dedicated UL channels.
2. In case of separate TCI state indication, wherein different beams are used for DL and UL channels, a DL TCI state that may be used at least for UE-dedicated DL channels.
3. In case of separate TCI state indication, wherein different beams are used for DL and UL channels, a UL TCI state that may be used at least for UE-dedicated UL channels.

The unified (master or main or indicated) TCI state is a DL or a Joint TCI state of UE-dedicated reception on PDSCH/PDCCH and the CSI-RS applying the indicated TCI state and/or an UL or a Joint TCI state for dynamic-grant/configured-grant based PUSCH, PUCCH, and SRS applying the indicated TCI state.

The unified TCI framework applies to intra-cell beam management, wherein, the TCI states have a source RS that is directly or indirectly associated, through a quasi-co-location relation, e.g., spatial relation, with an SSB of a serving cell (e.g., the TCI state is associated with a TRP of a serving cell). The unified TCI state framework also applies to inter-cell beam management, wherein a TCI state may have a source RS that is directly or indirectly associated, through a quasi-co-location relation, e.g., spatial relation, with an SSB of cell that has a physical cell identity (PCI) different from the PCI of the serving cell (e.g., the TCI state is associated with a TRP of a cell having a PCI different from the PCI of the serving cell). In Rel-17, UE-dedicated channels may be received and/or transmitted using a TCI state associated with a cell having a PCI different from the PCI of the serving cell. While the common channels may be received and/or transmitted using a TCI state associated with the serving cell (e.g., not associated with a cell having a PCI different from the PCI of the serving cell). In one example, common channels may include channels carrying system information (e.g., system information block1 (SIB1)) with a DL assignment carried by a DCI in PDCCH having a CRC scrambled by SI-RNTI and transmitted in Type0-PDCCH CSS set.

In another example, common channels may include channels carrying other system information with a DL assignment carried by a DCI in PDCCH having a CRC scrambled by SI-RNTI and transmitted in Type0A-PDCCH CSS set.

In another example, common channels may include channels carrying paging or short messages with a DL assignment carried by a DCI in PDCCH having a CRC scrambled by P-RNTI and transmitted in Type2-PDCCH CSS set.

In another example, common channels may include channels carrying RACH related channels with a DL assignment or UL grant carried by a DCI in PDCCH having a CRC scrambled by RA-RNTI or TC-RNTI and transmitted in Type1-PDCCH CSS set.

A DL-related DCI Format (e.g., DCI Format 1_1 or DCI Format 1_2), with or without DL assignment, may indicate to a UE through a field “transmission configuration indication” a TCI state code point, wherein, the TCI state codepoint may be one of (1) a DL TCI state; (2) an UL TCI state; (3) a joint TCI state; or (4) a pair of DL TCI state and UL TCI state. TCI state code points may be activated by media access control-control element (MAC CE) signaling.

Quasi-co-location (QCL) relation, may be quasi-location with respect to one or more of the following relations [38.214-section 5.1.5]:

Type A, {Doppler shift, Doppler spread, average delay, delay spread}
Type B, {Doppler shift, Doppler spread}
Type C, {Doppler shift, average delay}
Type D, {Spatial Rx parameter}

In addition, quasi-co-location relation may also provide a spatial relation for UL channels, e.g., a DL source reference signal provides information on the spatial domain filter to be used for UL transmissions, or the UL source reference signal provides the spatial domain filter to be used for UL transmissions, e.g., same spatial domain filter for UL source reference signal and UL transmissions.

The unified (master or main or indicated) TCI state applies at least to UE dedicated DL and UL channels. The unified (master or main or indicated) TCI may also apply to other DL and/or UL channels and/or signals e.g., non-UE dedicated channel and sounding reference signal (SRS).

In Rel-18, a new work item has been agreed to further enhance mobility in NR. “When the UE moves from the coverage area of one cell to another cell, at some point a serving cell change needs to be performed. Currently serving cell change is triggered by L3 measurements and is done by RRC signaling triggered Reconfiguration with Synchronization for change of PCell and PSCell, as well as release add for SCells when applicable. All cases involve complete L2 (and L1) resets, leading to longer latency, larger overhead and longer interruption time than beam switch mobility. The goal of L1/L2 mobility enhancements is to enable a serving cell change via L1/L2 signaling, in order to reduce the latency, overhead and interruption time.” Allowing, the serving cell to be changed seamlessly using L1/L2 mechanisms reduces handover latency, and leads to more robust operation (less dropped calls). In this disclosure, we look at mechanisms for handover triggered by beam switching from the beam of one cell to the beam of another cell.

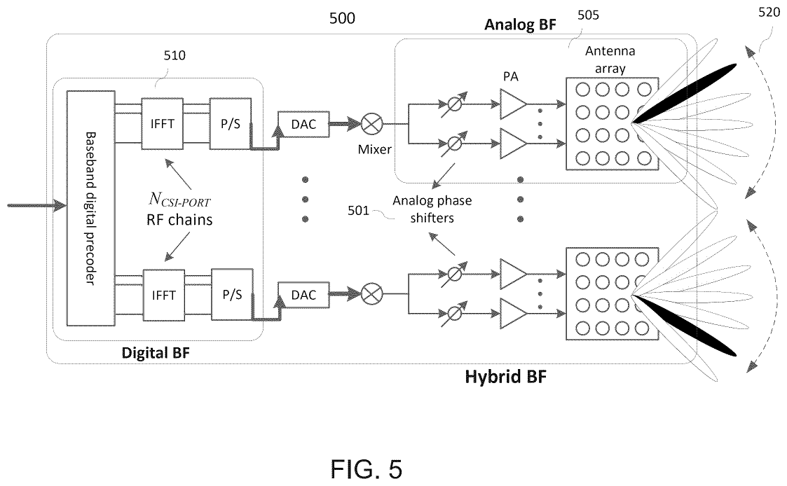

FIG. 6 illustrates an example of a beam change 600 from the TRP of a serving cell, to a TRP of a cell with PCI different from that of the serving cell according to the present disclosure. The embodiment of the beam change shown in FIG. 6 is for illustration only. Other embodiments of the beam change could be used without departing from the present disclosure.

In Rel-17, a unified TCI state framework has been introduced to streamline the beam management procedures by reducing latency and overhead associated with beam change. Rel-17 also introduced inter-cell beam management, wherein at least UE dedicated channels may be received on a beam associated with a TRP associated with a PCI different from the PCI of the serving cell. In Rel-17, when a beam changes from the TRP of serving cell, to a TRP of a cell with PCI different from that of the serving cell, the serving cell is not changed, as illustrated in FIG. 6. Common channels, continue to be received and transmitted on beams associated with a serving cell.

In Rel-17 a unified or master or main or indicated TCI state is signaled to the UE to indicate a beam for the UE to use. RRC signaling configures Rel-17 TCI states wherein TCI state may be configured as DL or Joint TCI state using information element (DLorJoint-TCIState), or UL TCI state using information element (UL-TCIState). MAC signaling may activate one or more TCI codepoints. When one TCI state codepoint is activated by MAC CE, the UE applies the TCI state(s) associated with the activated codepoint after a beam application time. When more than one TCI codepoints are activated by MAC CE, further DCI signaling may be used to indicate a TCI state codepoint to the UE. The unified TCI state may be signaled by a DCI Format (e.g., DL related DCI Format (e.g., DCI Format 1_1 or DCI Format 1_2) with a DL assignment or a DL related DCI Format (e.g., DCI Format 1_1 or DCI Format 1_2) without a DL assignment.

To further enhance mobility, the UE may initiate handover from a source cell to a target (or candidate) cell. The UE may inform the network (e.g., source cell and/or target (or candidate) cell) of the handover initiation and the network may respond by completing the handover procedure. In this disclosure, we consider methods for the UE to inform the network of a UE initiated handover and for the network to respond to a UE initiated handover request and completion of a dynamic cell switch.

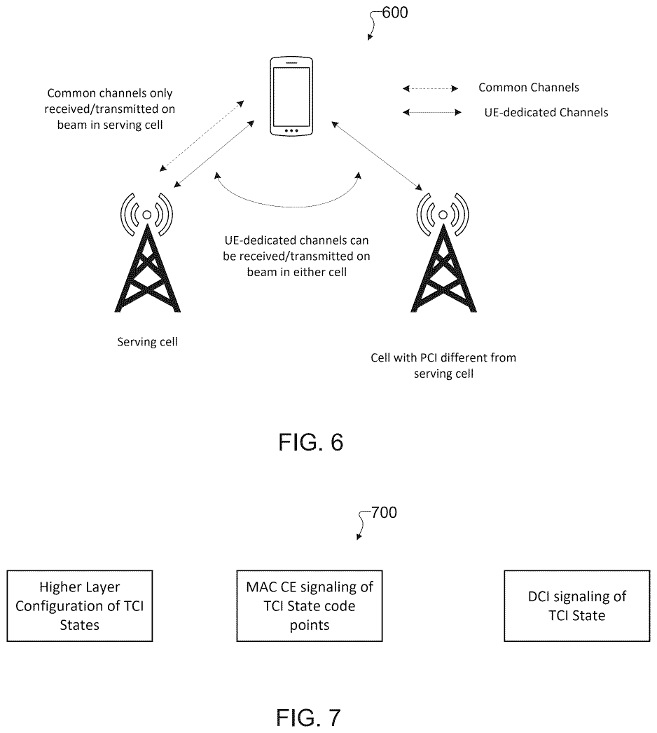

FIG. 7 illustrates an example of UE configuration 700 according to the present disclosure. The embodiment of the UE configuration shown in FIG. 7 is for illustration only. Other embodiments of the UE configuration could be used without departing from the scope of this disclosure.

In the following examples, as illustrated in FIG. 7, a UE is configured/updated through higher layer RRC signaling a set of TCI States with N elements. In one example, DL and joint TCI states may be configured by higher layer parameter DLorJoint-TCIState, wherein, the number of DL and Joint TCI state is N_{DJ}. UL TCI state may be configured by higher layer parameter UL-TCIState, wherein the number of UL TCI state is N_{U}·N, the total number of configured TCI states, can be given by: N=N_{DJ}+N_{U}. In one example, the TCI states may be configured for source serving cell and one or more target serving cells. The DLorJoint-TCIState may include DL or Joint TCI states that belong to a serving cell, e.g., the source RS of the TCI state is associated with the serving cell (the PCI of the serving cell). Additionally, the DL or Joint TCI states may be associated with a cell having a PCI different from the PCI of the serving cell, e.g., the source RS of the TCI state is associated with a cell having a PCI different from the PCI of the serving cell. The UL-TCIState may include UL TCI states that belong to a serving cell, e.g., the source RS of the TCI state may be associated with the serving cell (the PCI of the serving cell). Additionally, the UL TCI states may be associated with a cell having a PCI different from the PCI of the serving cell, e.g., the source RS of the TCI state may be associated with a cell having a PCI different from the PCI of the serving cell.

MAC CE signaling may include a subset of M (M≤N) TCI states or TCI state code points from the set of N TCI states, wherein a code point is signaled in the “transmission configuration indication” field of a DCI used for indication of the TCI state. A codepoint may include one TCI state (e.g., DL TCI state or UL TCI state or Joint (DL and UL) TCI state). Alternatively, a codepoint may include two TCI states (e.g., a DL TCI state and an UL TCI state). L1 control signaling (i.e., Downlink Control Information (DCI)) may update the UE's TCI state, wherein the DCI may include a “transmission configuration indication” (beam indication) field e.g., with m bits (such that M≤2^{m}), the TCI state may correspond to a code point signaled by MAC CE. A DCI used for indication of the TCI state may be a DL related DCI Format (e.g., DCI Format 1_1 or DCI Format 1_2), with a DL assignment or without a DL assignment.

The TCI states may be associated, through a QCL relation, with an SSB or reference signal of serving cell, or an SSB or reference signal associated with a PCI different from the PCI of the serving cell. The QCL relation with a SSB may be a direct QCL relation, wherein the source RS (e.g., for a QCL Type D relation or a spatial relation) of the QCL state is the SSB. The QCL relation with a SSB may be an indirect QCL relation, wherein, the source RS (e.g., for a QCL Type D relation or a spatial relation) may be a reference signal, and the reference signal has the SSB as its source (e.g., for a QCL Type D relation or a spatial relation). The indirect QCL relation to an SSB may involve a QCL or spatial relation chain of more than one reference signal.

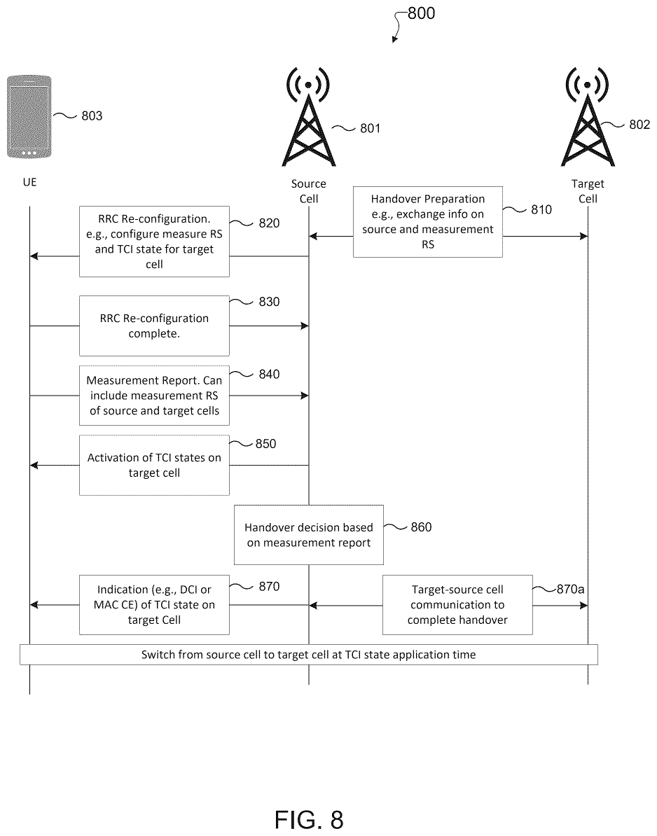

In one embodiment dynamic switch of serving cell is based on TCI state indication as illustrated in FIG. 8.

FIG. 8 illustrates an example method 800 of handover based on TCI state indication according to the present disclosure. The embodiment of the method of handover shown in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of the method of handover could be used without departing from the scope of this disclosure.

At step 810 of FIG. 8, a handover preparation occurs between source cell 801 and target (or candidate) cell 802. Source cell 801 may be a serving cell associated with a physical cell identity (PCI). Target (or candidate) cell 802 may be a second cell associated with a PCI different from the PCI of the serving cell (source cell). There may be one or more target (or candidate) cells, each target (or candidate) cell may have its own PCI. In one example, if there is more than one target (or candidate) cell, each target (or candidate) cell may have a PCI different from the PCI of other target (or candidate) cells. In one example, if there is more than one target (or candidate) cell, each target (or candidate) cell may have a PCI that is the same as the PCI of the other target (or candidate) cells. In one example, if there is more than one target (or candidate) cell, each subset of target (or candidate) cells may have a PCI that is the same as the PCI of the other target (or candidate) cells in the same subset, other subsets of target (or candidate) cells may have different PCIs.

In one example, the handover preparation may include exchange of reference signals between cells involved in the potential handover. For example, the reference signals may be measurement reference signals, wherein the measurement reference signals are used for measurement reports from the UE. The measurement signals may be used for example, to identify new candidate beams in the serving (e.g., source cell) or in a target (or candidate) cell(s). The measurement signals may be used for example to determine if handover should be triggered or performed from the source cell to a target (or candidate) cell. The measurement metric on the measurement reference signal may be an L1-reference signal receive power (L1-RSRP), a signal to interference and noise ratio (SINR) derived based on the measurement reference signal, block error rate (BLER), a channel quality indicator (CQI), an L3-RSRP, wherein the L3-RSRP is a long term averaged (e.g., exponential averaging) of the L1-RSRP, or some other quality metric determined based on the measurement reference signal. Measurement reference signals may include DL measurement reference signals transmitted from the network (e.g., gNB or TRP of source cell or target (or candidate) cell(s)), wherein the measurement may be performed in the UE and reported to the network in a measurement report. Measurement reference signals may include UL measurement reference signals (e.g., SRS) transmitted by the UE, wherein the measurement is performed in the network (e.g., gNB or TRP of source cell or target (or candidate) cell(s)). In one example, a measurement reference signal may be used as a source reference signal.

In another example, the reference signals may be source reference signals, wherein the source reference signals are used in the TCI state to determine the source of a quasi-colocation (QCL) (e.g., the source RS for QCL-TypeA, or QCL-TypeB or QCL-TypeC or QCL-TypeD); or to determine the source of the spatial relation (e.g., to determine a spatial relation receive filter or a spatial relation transmit filter). Source reference signals may include DL reference signals transmitted from the network (e.g., gNB or TRP of source cell or target (or candidate) cell(s)). Source reference signals may include UL reference signals (e.g., SRS) transmitted by the UE. In one example, a source reference signal may be used as a measurement reference signal.

In one example, the reference signal (e.g., measurement reference signal or source reference signal) may be a Synchronization Signal Block (SSB) (synchronization signal/physical broadcast channel (PBCH) Block), wherein the SSB may be associated with a PCI of a serving cell (e.g., source cell), or a PCI of a cell that is different from the PCI of the serving cell (e.g., a target (or candidate) cell). In one example, the association may be by inclusion of a PCI in the configuration of SSB resource or the information element (IE) including the SSB resource. In another example, the association may be by configuration of the SSB resource as part of the configuration of the cell associated with the PCI.

In another example, the reference signal may be channel state information-reference signal (CSI-RS). The CSI-RS may be for example, CSI-RS for mobility (e.g., used for handover), or CSI-RS for beam management or CSI-RS for tracking or CSI-RS for CSI acquisition. The CSI-RS may be associated with a PCI of a serving cell (e.g., source cell), or a PCI of a cell that is different from the PCI of the serving cell (e.g., a target (or candidate) cell). In one example, the association may be through a QCL relation with an SSB, or CSI-RS associated with a PCI of a cell. In another example, the association may be by inclusion of a PCI in the configuration of CSI-RS resource or the information element (IE) including the CSI-RS resource. In another example, the association may be by configuration of the CSI-RS resource as part of the configuration of the cell associated with the PCI.

In another example, the reference signal may be a sounding reference signal (SRS), wherein the SRS is transmitted by the UE. In one example, the SRS may be an SRS resource for beam management. In another example, the SRS may be an SRS resource for codebook. In another example, the SRS may be an SRS resource for non-codebook. In another example, the SRS may be an SRS resource for antenna switching. In another example, the SRS may be an SRS resource for mobility (e.g., used for handover). In one example, the SRS may be associated with a PCI of a serving cell (e.g., source cell), or a PCI of a cell that is different from the PCI of the serving cell (e.g., a target (or candidate) cell). In one example, the SRS may not be associated with a PCI of a cell (e.g., the SRS may be transmitted by the UE and may be received by any cell). In one example, the association may be through a QCL relation or a spatial relation with an SSB or CSI-RS or SRS associated with a PCI of a cell. In another example, the association may be by inclusion of a PCI in the configuration of SRS resource or the information element (IE) including the SRS resource. In another example, the association may be by configuration of the SRS resource as part of the configuration of the cell associated with the PCI.

In one example, the handover preparation may include exchange of transmission configuration indication (TCI) states between cells involved in the potential handover. For example, the TCI state may include a DL or Joint TCI state (DLorJoint-TCIState) that includes for example one or more of: (1) TCI state ID; (2) first QCL info; (3) second QCL info; (4) UL power control ID; (5) path loss reference signal ID; and (6) associated PCI (alternatively, the associated PCI may be included in the QCL Info). The QCL-Info may include (1) serving cell index; (2) BWP ID; (3) reference signal ID (e.g., CSI-RS resource ID or SSB-Index); (4) QCL Type (e.g., typeA, typeB, typeC, or typeD); and (5) PCI index, alternatively the PCI Index may be part of the reference signal ID.

In another example, the TCI state may include a UL TCI state (UL-TCIState) that includes for example one or more of: (1) TCI state ID; (2) serving cell index; (3) reference signal ID (e.g., CSI-RS resource ID or SSB-Index or SRS resource ID); (4) PCI index, alternatively the PCI Index may be part of the reference signal ID; (5) UL power control ID; and (6) path loss reference signal ID.

At step 820 of FIG. 8, the network performs RRC (re-) configuration towards the UE 803. For example, a reconfiguration message may include information related to one or more target (or candidate) cells. For example, the information may include one or more of reference signals of target (or candidate) cell(s) (e.g., measurement reference signals or source reference signals as aforementioned) or TCI states of target (or candidate) cell(s) as aforementioned.

At step 830 of FIG. 8, UE 803 responds with RRC (re-) configuration complete.

At step 840 of FIG. 8, UE 803 performs measurements on the configured measurement reference signals of source cell 801 and one or more target (or candidate) cell(s). The UE may provide a measurement report to the source cell. The measurement report may include one or more pairs of (1) measurement reference signal ID (e.g., of the source cell or of a target (or candidate) cell); (2) quality metric (e.g., L1-RSRP, SINR, BLER, CQI, L3-RSRP . . . as aforementioned). The measurement report may include measurements from the source cell only, or from a target (or candidate) cell only, or from the source cell and a target (or candidate) cell, or from one or more target (or candidate) cells, or from a source cell and one or more target (or candidate) cells. The number of cells in a measurement report may be limited (e.g., by system specifications and/or by RRC configuration and/or MAC CE signaling and/or L1 control signaling). The number of measurement pairs (e.g., measurement pairs per cell) in a measurement report may be limited (e.g., by system specifications and/or by RRC configuration and/or MAC CE signaling and/or L1 control signaling). L1 control signaling may be a DL control information (DCI) signal. When multiple measurement pairs are reported, differential signaling (reporting) may be used. For example, a metric of the first pair (e.g., first pair in measurement report or first pair associated with a cell in a measurement report) may be an absolute value, this is the pair with the best beam metric (e.g., in the measurement report or per cell in the measurement report). Other pairs (e.g., across all cells or per cell) in the same report may be relative to the metric of the first pair (e.g., first pair in measurement report or first pair associated with a cell in a measurement report) (or alternatively the metric of the previous pair) with a step size of A dB for example. The second pair, if present, may have a metric n₁Δ dB below the metric of the first pair, where n₁ is signaled. The third pair, if present, may have a metric n₂ΔdB below the metric of the first pair (or alternatively the second pair), where n₂ is signaled, and so on.

In one example, the measurement reports may be configured periodically. In one example, the measurement reports may be configured semi-persistently, with a dynamic signal (e.g., by MAC CE or L1 control) to activate or deactivate the transmission of the measurement report. In one example, the measurement report may be triggered aperiodically using a dynamic signal (e.g., by MAC CE or L1 control). In one example, the measurement report may be UE initiated; for example, the UE may send a scheduling request for UL resources to send the measurement report, or the UE may send the measurement report in a configured grant (Type 1 or Type 2 configured grant) resource or the UE may send the measurement report using a random access procedure (e.g., Type 1 random access procedure or Type 2 random access procedure).

In one example, the measurement reports may be reported in uplink control information (UCI) in a physical uplink control channel (PUCCH). In one example, if the PUCCH overlaps with a physical uplink shared channel (PUSCH), the PUCCH may not be transmitted, and the UCI may be multiplexed into the PUSCH. In one example, the measurement reports may be reported in UCI in a PUSCH. In one example, the measurement reports may be reported in MAC CE. In one example, the measurement reports may be reported in a single stage UCI. In another example, the measurement reports may be reported in a two stage UCI. For example, the first stage may include information about the number of measurement pairs (e.g., measurement pairs per cell) or the number of cells with reported measurements, and the measurement pairs may be reported in the second stage of the UCI.

At step 850 of FIG. 8, source cell 801 determines which TCI states to activate. For example, the TCI states to activate may belong to the source cell or to one or more target (or candidate) cells. In one example, the number of cells with activated TCI states may be limited (e.g., by system specifications and/or by RRC configuration and/or MAC CE signaling and/or L1 control signaling). In one example, the activated TCI states may be on the source cell and an additional target (or candidate) cell. In one example, the activated TCI states may be indicated by MAC CE signaling, wherein MAC CE signaling activates TCI state code points as aforementioned. In one example, some or all of the activated TCI state code points may belong to a target (or candidate) cell. In one example a single code point may be activated and hence applied after a beam application delay.

At step 860 of FIG. 8, source cell 801 makes a decision on handover to target (or candidate) cell 802 based on the measurement report from UE 803 (step 840). To trigger handover to a target (or candidate) cell, the network may indicate to UE 803 a beam (TCI state) associated with target (or candidate) cell 802.

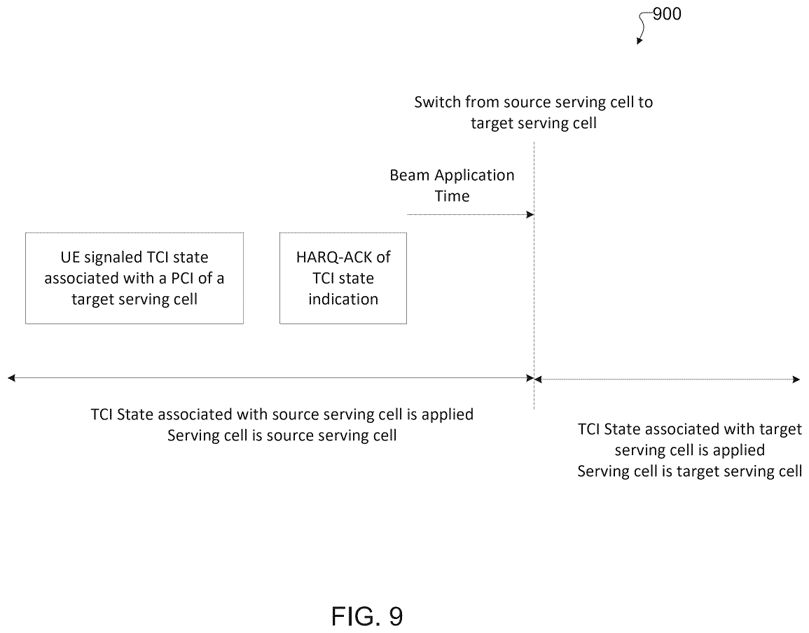

At step 870 of FIG. 8, a TCI state code point is indicated to UE 803. The TCI state code point may be indicated by a DL related DCI format, wherein the DL related DCI format may be one of DCI Format 1_1 or DCI Format 1_2. The DCI Format may include a “transmission configuration indication” field to indicate a code point of MAC CE activated TCI state code point. In one example, the DCI Format may include a DL assignment, in another example, the DCI Format may not include a DL assignment. In one example, the indicated TCI state code point is associated with a target (or candidate) cell. In one example, the TCI state code point may be indicated in a MAC CE as illustrated in FIG. 8. This may trigger a handover to the target (or candidate) cell after a beam application delay as illustrated in FIG. 9.

FIG. 9 illustrates an example method 900 of handover to a target (or candidate) cell after a beam application delay according to the present disclosure. The embodiment of the method of handover shown in FIG. 9 is for illustration only. Other embodiments of the method of handover could be used without departing from the scope of this disclosure.

Although FIG. 9 illustrates one example of a method 900 of handover to a target (or candidate) cell after a beam application delay, various changes may be made to FIG. 9. For example, while shown as a series of steps, various steps in FIG. 9 could overlap, occur in parallel, occur in a different order, or occur any number of times.

At step 870a of FIG. 8, information is exchanged between source cell 801 and target (or candidate) cell 802 to complete the handover at the beam application time.

Although FIG. 8 illustrates one example of a method 800 of handover based on TCI state indication, various changes may be made to FIG. 8. For example, while shown as a series of steps, various steps in FIG. 8 could overlap, occur in parallel, occur in a different order, or occur any number of times.

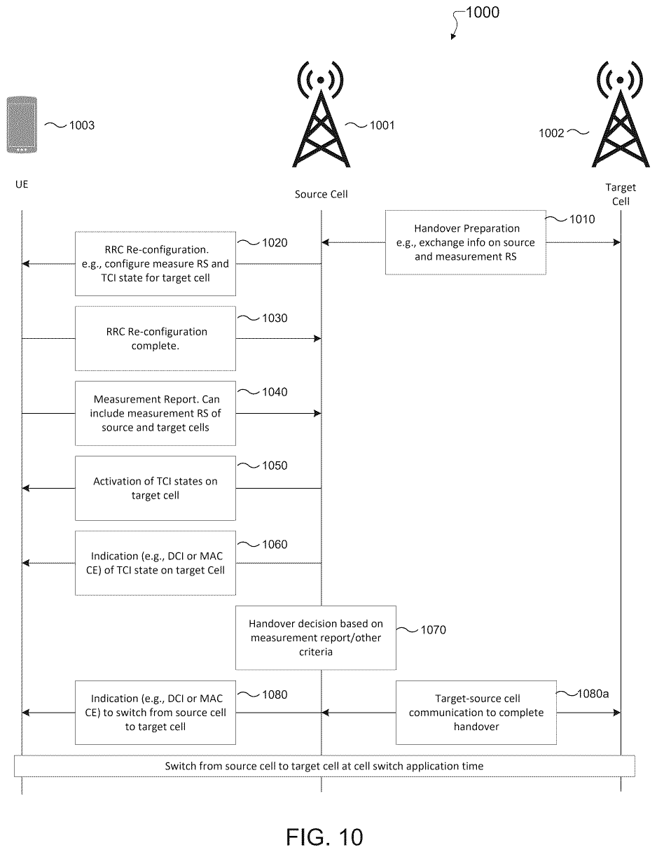

In one embodiment a dynamic switch of a serving cell is based on TCI state indication and a dynamic cell switch signal as illustrated in FIG. 10.

FIG. 10 illustrates an example method 1000 of handover based on TCI state indication according to the present disclosure. The embodiment of the method of handover shown in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of the method of handover could be used without departing from the scope of this disclosure.

At step 1010 of FIG. 10, handover preparation occurs between source cell and 1001 target (or candidate) cell 1002. Source cell 1001 may be a serving cell associated with a physical cell identity (PCI). Target (or candidate) cell 1002 may be a second cell associated with a PCI different from the PCI of the serving cell (source cell). There may be one or more target (or candidate) cells, each target (or candidate) cell may have its own PCI. In one example, if there is more than one target (or candidate) cell, each target (or candidate) cell may have a PCI different from the PCI of other target (or candidate) cells. In one example, if there is more than one target (or candidate) cell, each target (or candidate) cell may have a PCI that is the same as the PCI of the other target (or candidate) cells. In one example, if there is more than one target (or candidate) cell, each subset of target (or candidate) cells may have a PCI that is the same as the PCI of the other target (or candidate) cells in the same subset, other subsets of target (or candidate) cells may have different PCIs.

In one example, the handover preparation may include exchange of reference signals between cells involved in the potential handover. For example, the reference signals may be measurement reference signals, wherein the measurement reference signals are used for measurement reports from the UE. The measurement signals may be used for example, to identify new candidate beams in the serving (e.g., source cell) or in a target (or candidate) cell(s). The measurement signals may be used for example to determine if handover should be triggered or performed from the source cell to a target (or candidate) cell. The measurement metric on the measurement reference signal may be L1-reference signal receive power (L1-RSRP), signal to interference and noise ratio (SINR) derived based on the measurement reference signal, block error rate (BLER), channel quality indicator (CQI), L3-RSRP, wherein the L3-RSRP is a long term averaged (e.g., exponential averaging) of the L1-RSRP, or some other quality metric determined based on the measurement reference signal. Measurement reference signals may include DL measurement reference signals transmitted from the network (e.g., gNB or TRP of source cell or target (or candidate) cell(s)), wherein the measurement may be performed in the UE and reported to the network in a measurement report. Measurement reference signals may include UL measurement reference signals (e.g., SRS) transmitted by the UE, wherein the measurement is performed in the network (e.g., gNB or TRP of source cell or target (or candidate) cell(s)). In one example, a measurement reference signal may be used as a source reference signal.

In another example, the reference signals may be source reference signals, wherein the source reference signals are used in the TCI state to determine the source of a quasi-colocation (QCL) (e.g., the source RS for QCL-TypeA, or QCL-TypeB or QCL-TypeC or QCL-TypeD); or to determine the source of the spatial relation (e.g., to determine a spatial relation receive filter or a spatial relation transmit filter). Source reference signals may include DL reference signals transmitted from the network (e.g., gNB or TRP of source cell or target (or candidate) cell(s)). Source reference signals may include UL reference signals (e.g., SRS) transmitted by the UE. In one example, a source reference signal may be used as a measurement reference signal.

In one example, the reference signal (e.g., measurement reference signal or source reference signal) may be a Synchronization Signal Block (SSB) (synchronization signal/physical broadcast channel (PBCH) Block), wherein the SSB may be associated with a PCI of a serving cell (e.g., source cell), or a PCI of a cell that is different from the PCI of the serving cell (e.g., a target (or candidate) cell). In one example, the association may be by inclusion of a PCI in the configuration of SSB resource or the information element (IE) including the SSB resource. In another example, the association may be by configuration of the SSB resource as part of the configuration of the cell associated with the PCI.

In another example the reference signal may be a channel state information reference signal (CSI-RS). The CSI-RS may be for example, CSI-RS for mobility (e.g., used for handover), or CSI-RS for beam management or CSI-RS for tracking or CSI-RS for CSI acquisition. The CSI-RS may be associated with a PCI of a serving cell (e.g., source cell), or a PCI of a cell that is different from the PCI of the serving cell (e.g., a target (or candidate) cell). In one example, the association may be through a QCL relation with an SSB, or CSI-RS associated with a PCI of a cell. In another example, the association may be by inclusion of a PCI in the configuration of CSI-RS resource or the information element (IE) including the CSI-RS resource. In another example, the association may be by configuration of the CSI-RS resource as part of the configuration of the cell associated with the PCI.

In another example the reference signal may be a sounding reference signal (SRS), wherein the SRS is transmitted by the UE. In one example, the SRS may be an SRS resource for beam management. In another example, the SRS may be an SRS resource for codebook. In another example, the SRS may be an SRS resource for non-codebook. In another example, the SRS may be an SRS resource for antenna switching. In another example, the SRS may be an SRS resource for mobility (e.g., used for handover). In one example, the SRS may be associated with a PCI of a serving cell (e.g., source cell), or a PCI of a cell that is different from the PCI of the serving cell (e.g., a target (or candidate) cell). In one example, the SRS may be not associated with a PCI of a cell (e.g., the SRS may be transmitted by the UE and may be received by any cell). In one example, the association may be through a QCL relation or a spatial relation with an SSB or CSI-RS or SRS associated with a PCI of a cell. In another example, the association may be by inclusion of a PCI in the configuration of SRS resource or the information element (IE) including the SRS resource. In another example, the association may be by configuration of the SRS resource as part of the configuration of the cell associated with the PCI.

In one example, the handover preparation may include exchange of transmission configuration indication (TCI) states between cells involved in the potential handover. For example, the TCI state may include a DL or Joint TCI state (DLorJoint-TCIState) that includes for example one or more of: (1) TCI state ID; (2) first QCL info; (3) second QCL info; (4) UL power control ID; (5) path loss reference signal ID; and (6) associated PCI (alternatively, the associated PCI may be included in the QCL Info). The QCL-Info may include (1) serving cell index; (2) BWP ID; (3) reference signal ID (e.g., CSI-RS resource ID or SSB-Index); (4) QCL Type (e.g., typeA, typeB, typeC, or typeD); and (5) PCI index, alternatively the PCI Index may be part of the reference signal ID.

In another example, the TCI state may include a UL TCI state (UL-TCIState) that includes for example one or more of: (1) TCI state ID; (2) serving cell index; (3) reference signal ID (e.g., CSI-RS resource ID or SSB-Index or SRS resource ID); (4) PCI index, alternatively the PCI Index may be part of the reference signal ID; (5) UL power control ID; and (6) path loss reference signal ID.

At step 1020 of FIG. 10, the network performs RRC (re-) configuration towards UE 1003. For example, a reconfiguration message may include information related to one or more target (or candidate) cells. For example, the information may include one or more of reference signals of target (or candidate) cell(s) (e.g., measurement reference signals or source reference signals as aforementioned) or TCI states of target (or candidate) cell(s) as aforementioned.

At step 1030 of FIG. 10, UE 1003 responds with RRC (re-) configuration complete.

At step 1040 of FIG. 10, UE 1003 performs measurements on the configured measurement reference signals of the source cell and one or more target (or candidate) cell(s). UE 1003 may provide a measurement report to the source cell. The measurement report may include one or more pairs of (1) measurement reference signal ID (e.g., of the source cell or of a target (or candidate) cell); (2) quality metric (e.g., L1-RSRP, SINR, BLER, CQI, L3-RSRP, as aforementioned). The measurement report may include measurements from a source cell only, or from a target (or candidate) cell only, or from a source cell and a target (or candidate) cell, or from one or more target (or candidate) cells, or from a source cell and one or more target (or candidate) cells. The number of cells in a measurement report may be limited (e.g., by system specifications and/or by RRC configuration and/or MAC CE signaling and/or L1 control signaling). The number of measurement pairs (e.g., measurement pairs per cell) in a measurement report may be limited (e.g., by system specifications and/or by RRC configuration and/or MAC CE signaling and/or L1 control signaling). L1 control signaling may be a DL control information (DCI) signal. When multiple measurement pairs are reported, differential signaling (reporting) may be used. For example, a metric of the first pair (e.g., first pair in measurement report or first pair associated with a cell in a measurement report) may be an absolute value. This may be the pair with the best beam metric (e.g., in the measurement report or per cell in the measurement report). In another example, other pairs (e.g., across all cells or per cell) in the same report may be relative to the metric of the first pair (e.g., first pair in measurement report or first pair associated with a cell in a measurement report) (or alternatively the metric of the previous pair) with a step size of A dB for example. The second pair, if present, may have a metric n₁ΔdB below the metric of the first pair, where n₁ is signaled. The third pair, if present, may have a metric n₂ΔdB below the metric of the first pair (or alternatively the second pair), where n₂ is signaled, and so on.

In one example, the measurement reports may be configured periodically. In one example, the measurement reports may be configured semi-persistently, with a dynamic signal (e.g., by MAC CE or L1 control) to activate or deactivate the transmission of the measurement report. In one example, the measurement report may be triggered aperiodically using a dynamic signal (e.g., by MAC CE or L1 control). In one example, the measurement report may be UE initiated; for example, the UE may send a scheduling request for UL resources to send the measurement report, or the UE may send the measurement report in a configured grant (Type 1 or Type 2 configured grant) resource or the UE may send the measurement report using a random access procedure (e.g., Type 1 random access procedure or Type 2 random access procedure).

In one example, the measurement reports may be reported in uplink control information (UCI) in a physical uplink control channel (PUCCH). In one example, if the PUCCH overlaps with a physical uplink shared channel (PUSCH), the PUCCH may not be transmitted, and the UCI may be multiplexed into the PUSCH. In one example, the measurement reports may be reported in UCI in a PUSCH. In one example, the measurement reports may be reported in MAC CE. In one example, the measurement reports may be reported in a single stage UCI. In another example, the measurement reports may be reported in a two stage UCI. For example, the first stage may include information about the number of measurement pairs (e.g., measurement pairs per cell) or the number of cells with reported measurements, and the measurement pairs are reported in the second stage of the UCI.

At step 1050 of FIG. 10, source cell 1001 determines which TCI states to activate. For example, the TCI states to activate may belong to the source cell or to one or more target (or candidate) cells. In one example, the number of cells with activated TCI states may be limited (e.g., by system specifications and/or by RRC configuration and/or MAC CE signaling and/or L1 control signaling). In one example, the activated TCI states may be on the source cell and an additional target (or candidate) cell. In one example, the activated TCI states may be indicated by MAC CE signaling, wherein MAC CE signaling activates TCI state code points as aforementioned. In one example, some or all of the activated TCI state code points may belong to a target (or candidate) cell. In one example a single code point may activated and hence applied after a beam application delay.

At step 1060 of FIG. 10, a TCI state code point is indicated to UE 1003. The TCI state code point may be indicated by a DL related DCI Format, wherein the DL related DCI format may be one of DCI Format 1_1 or DCI Format 1_2. The DCI Format includes a “transmission configuration indication” field to indicate a code point of MAC CE activated TCI state code point. In one example, the DCI Format includes a DL assignment, in another example, the DCI Format doesn't include a DL assignment. In one example, the indicated TCI state code point belongs a cell with a PCI different from the PCI of the serving cell, this may be a target (or candidate) cell. In one example, the TCI state code point may be indicated in a MAC CE as illustrated in FIG. 10.

At step 1070 of FIG. 10, source cell 1001 makes a decision on handover to target (or candidate) cell 1002 based on the measurement report from UE 1003 (step 1040). To trigger handover to target (or candidate) cell 1002, the network may send a dynamic signal (e.g., using MAC CE and/or L1 control) to UE 1003 for handover. In one example, the signal for handover may be sent to UE 1003 after a TCI state of target (or candidate) cell 1002 has been indicated to UE 1003 or has been applied by UE 1003.

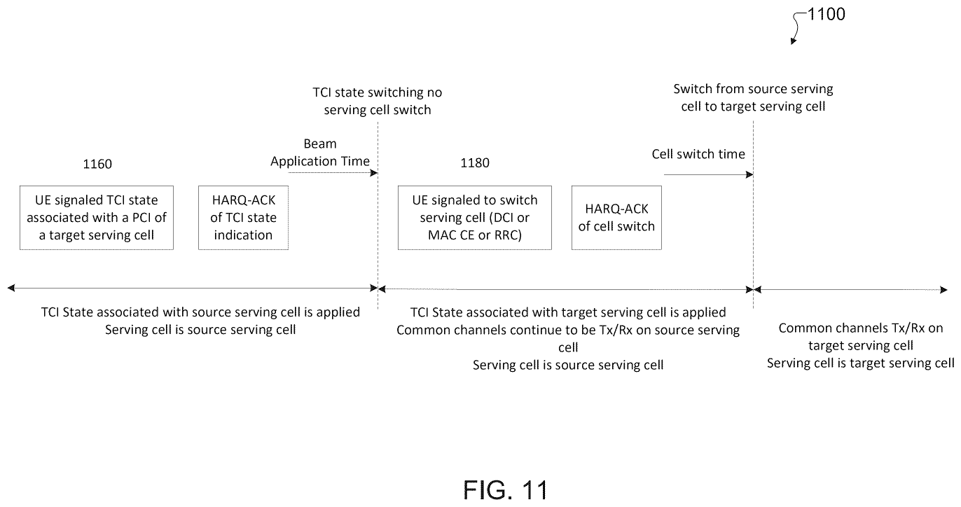

At step 1080 of FIG. 10, UE 1003 is indicated from source cell 1001 to switch from source cell 1001 to target (or candidate) cell 1002. The indication to switch from source cell 1001 to target (or candidate) cell 1002 may be RRC signaling and/or MAC CE signaling and/or L1 control signaling. In one example, the handover to the target (or candidate) cell after a cell switch application delay may be as illustrated in FIG. 11.

FIG. 11 illustrates an example method 1100 of handover to a target (or candidate) cell after a cell switch application delay according to the present disclosure. The embodiment of the method of handover shown in FIG. 11 is for illustration only. Other embodiments of the method of handover could be used without departing from the scope of this disclosure.

In one example, step 1160 of FIG. 11 may correspond with step 1060 of FIG. 10, and step 1180 of FIG. 11 may correspond with step 1080 of FIG. 10.

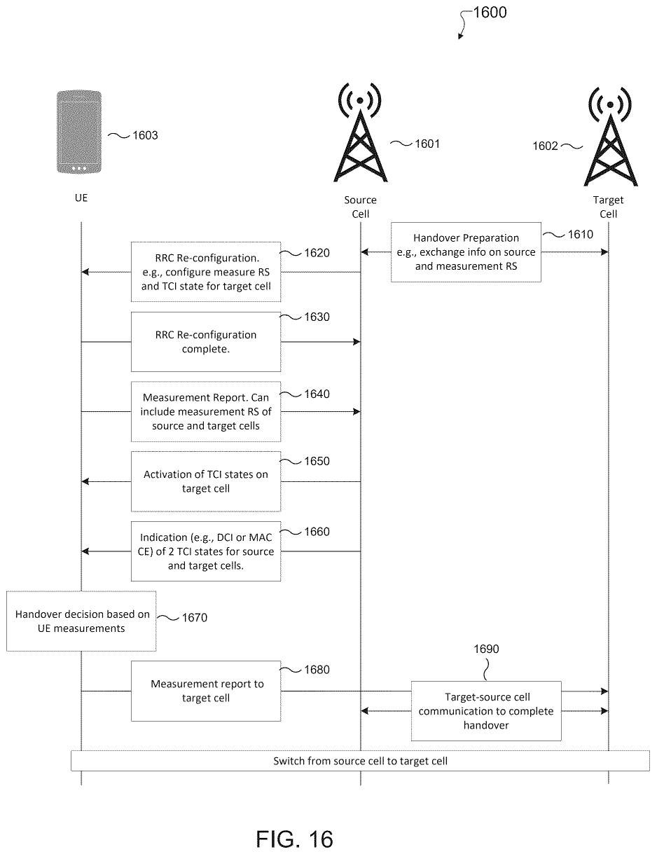

Although FIG. 11 illustrates one example of a method 1100 of handover to a target (or candidate) cell after a cell switch application delay, various changes may be made to FIG. 16. For example, while shown as a series of steps, various steps in FIG. 16 could overlap, occur in parallel, occur in a different order, or occur any number of times.

At step 1080a of FIG. 10, information is exchanged between source cell 1001 and target (or candidate) cell 1002 to complete the handover at the cell switch time.

Although FIG. 10 illustrates one example of a method 1000 of handover based on TCI state indication, various changes may be made to FIG. 10. For example, while shown as a series of steps, various steps in FIG. 10 could overlap, occur in parallel, occur in a different order, or occur any number of times.

In one embodiment dynamic switch of serving cell is based on UE initiation.

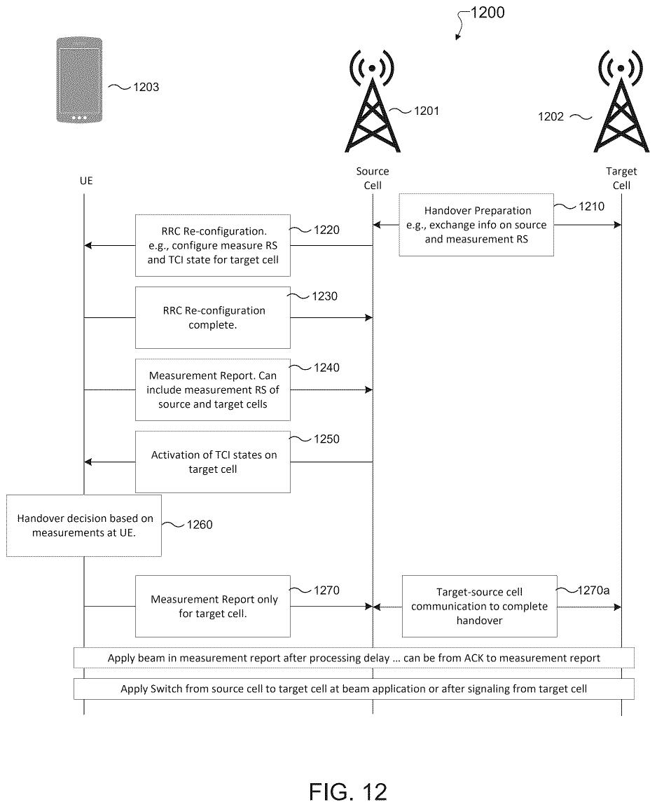

FIG. 12 illustrates an example method 1200 of handover based on UE initiation according to the present disclosure. The embodiment of the method illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of the method of handover could be used without departing from the scope of this disclosure.

At step 1210 of FIG. 12, a handover preparation occurs between source cell 1201 and target (or candidate) cell 1202. Source cell 1201 may be a serving cell associated with a physical cell identity (PCI). Target (or candidate) cell 1202 may be a second cell associated with a PCI different from the PCI of the serving cell (source cell). There may be one or more target (or candidate) cells, and each target (or candidate) cell may have its own PCI. In one example, if there is more than one target (or candidate) cell, each target (or candidate) cell may have a PCI different from the PCI of other target (or candidate) cells. In one example, if there is more than one target (or candidate) cell, each target (or candidate) cell may have a PCI that is the same as the PCI of the other target (or candidate) cells. In one example, if there is more than one target (or candidate) cell, each subset of target (or candidate) cells may have a PCI that is the same as the PCI of the other target (or candidate) cells in the same subset, other subsets of target (or candidate) cells may have different PCIs.

In one example, the handover preparation may include exchange of reference signals between cells involved in the potential handover. For example, the reference signals may be measurement reference signals, wherein the measurement reference signals are used for measurement reports from the UE. The measurement signals may be used for example, to identify new candidate beams in the serving (e.g., source cell) or in a target (or candidate) cell(s). The measurement signals may be used for example to determine if handover should be triggered or performed from the source cell to a target (or candidate) cell. The measurement metric on the measurement reference signal may be L1-reference signal receive power (L1-RSRP), signal to interference and noise ratio (SINR) derived based on the measurement reference signal, block error rate (BLER), channel quality indicator (CQI), L3-RSRP, wherein the L3-RSRP is a long term averaged (e.g., exponential averaging) of the L1-RSRP, or some other quality metric determined based on the measurement reference signal. Measurement reference signals may include DL measurement reference signals transmitted from the network (e.g., gNB or TRP of source cell or target (or candidate) cell(s)), wherein the measurement may be performed in the UE and reported to the network in a measurement report. Measurement reference signals may include UL measurement reference signals (e.g., SRS) transmitted by the UE, wherein the measurement is performed in the network (e.g., gNB or TRP of source cell or target (or candidate) cell(s)). In one example, a measurement reference signal is used as a source reference signal.

In another example, the reference signals may be source reference signals, wherein the source reference signals may be used in the TCI state to determine the source of a quasi-colocation (QCL) (e.g., the source RS for QCL-TypeA, or QCL-TypeB or QCL-TypeC or QCL-TypeD); or to determine the source of the spatial relation (e.g., to determine a spatial relation receive filter or a spatial relation transmit filter). Source reference signals may include DL reference signals transmitted from the network (e.g., gNB or TRP of source cell or target (or candidate) cell(s)). Source reference signals may include UL reference signals (e.g., SRS) transmitted by the UE. In one example, a source reference signal may be used as a measurement reference signal.

In one example, the reference signal (e.g., measurement reference signal or source reference signal) may be a Synchronization Signal Block (SSB) (synchronization signal/physical broadcast channel (PBCH) Block), wherein the SSB may be associated with a PCI of a serving cell (e.g., source cell), or a PCI of a cell that is different from the PCI of the serving cell (e.g., a target (or candidate) cell). In one example, the association may be by inclusion of a PCI in the configuration of SSB resource or the information element (IE) including the SSB resource. In another example, the association may be by configuration of the SSB resource as part of the configuration of the cell associated with the PCI.

In another example, the reference signal may be a Channel state information-reference signal (CSI-RS). The CSI-RS may be for example, CSI-RS for mobility (e.g., used for handover), or CSI-RS for beam management or CSI-RS for tracking or CSI-RS for CSI acquisition. The CSI-RS may be associated with a PCI of a serving cell (e.g., source cell), or a PCI of a cell that is different from the PCI of the serving cell (e.g., a target (or candidate) cell). In one example, the association may be through a QCL relation with an SSB, or CSI-RS associated with a PCI of a cell. In another example, the association may be by inclusion of a PCI in the configuration of CSI-RS resource or the information element (IE) including the CSI-RS resource. In another example, the association may be by configuration of the CSI-RS resource as part of the configuration of the cell associated with the PCI.

In another example, the reference signal may be a sounding reference signal (SRS), wherein the SRS is transmitted by the UE. In one example, the SRS may be an SRS resource for beam management. In another example, the SRS may be an SRS resource for codebook. In another example, the SRS may be an SRS resource for non-codebook. In another example, the SRS may be an SRS resource for antenna switching. In another example, the SRS may be an SRS resource for mobility (e.g., used for handover). In one example, the SRS may be associated with a PCI of a serving cell (e.g., source cell), or a PCI of a cell that is different from the PCI of the serving cell (e.g., a target (or candidate) cell). In one example, the SRS may not be associated with a PCI of a cell (e.g., the SRS may be transmitted by the UE and may be received by any cell). In one example, the association may be through a QCL relation or a spatial relation with an SSB or CSI-RS or SRS associated with a PCI of a cell. In another example, the association may be by inclusion of a PCI in the configuration of SRS resource or the information element (IE) including the SRS resource. In another example, the association may be by configuration of the SRS resource as part of the configuration of the cell associated with the PCI.

In one example, the handover preparation may include exchange of transmission configuration indication (TCI) states between cells involved in the potential handover. For example, the TCI state may include a DL or Joint TCI state (DLorJoint-TCIState) that includes for example one or more of: (1) TCI state ID; (2) first QCL info; (3) second QCL info; (4) UL power control ID; (5) path loss reference signal ID; and (6) associated PCI (alternatively, the associated PCI may be included in the QCL Info). The QCL-Info may include (1) serving cell index; (2) BWP ID; (3) reference signal ID (e.g., CSI-RS resource ID or SSB-Index); (4) QCL Type (e.g., typeA, typeB, typeC, or typeD); and (5) PCI index, alternatively the PCI Index may be part of the reference signal ID.

In another example, the TCI state may include a UL TCI state (UL-TCIState) that includes for example one or more of: (1) TCI state ID; (2) serving cell index; (3) reference signal ID (e.g., CSI-RS resource ID or SSB-Index or SRS resource ID); (4) PCI index, alternatively the PCI Index may be part of the reference signal ID; (5) UL power control ID; and (6) path loss reference signal ID.

At step 1220 of FIG. 12, the network performs RRC (re-) configuration towards UE 1203. For example, reconfiguration message may include information related to one or more target (or candidate) cells. For example, the information may include one or more of reference signals of target (or candidate) cell(s) (e.g., measurement reference signals or source reference signals as aforementioned) or TCI states of target (or candidate) cell(s) as aforementioned.

At step 1230 of FIG. 12, UE 1203 responds with RRC (re-) configuration complete.

At step 1240 of FIG. 12, UE 1203 performs measurements on the configured measurement reference signals of source cell 1201 and one or more target (or candidate) cell(s). UE 1203 provides a measurement report to the source cell. The measurement report may include one or more pairs of (1) measurement reference signal ID (e.g., of the source cell or of a target (or candidate) cell); (2) quality metric (e.g., L1-RSRP, SINR, BLER, CQI, L3-RSRP as aforementioned). The measurement report may include measurements from the source cell only, or from a target (or candidate) cell only, or from the source cell and a target (or candidate) cell, or from one or more target (or candidate) cells, or from a source cell and one or more target (or candidate) cells. The number of cells in a measurement report may be limited (e.g., by system specifications and/or by RRC configuration and/or MAC CE signaling and/or L1 control signaling). The number of measurement pairs (e.g., measurement pairs per cell) in a measurement report may be limited (e.g., by system specifications and/or by RRC configuration and/or MAC CE signaling and/or L1 control signaling). L1 control signaling may be a DL control information (DCI) signal. When multiple measurement pairs are reported, differential signaling (reporting) may be used, for example, metric of the first pair (e.g., first pair in measurement report or first pair associated with a cell in a measurement report) may be an absolute value. This may be the pair with the best beam metric (e.g., in the measurement report or per cell in the measurement report). Other pairs (e.g., across all cells or per cell) in the same report may be relative to the metric of the first pair (e.g., first pair in measurement report or first pair associated with a cell in a measurement report) (or alternatively the metric of the previous pair) with a step size of A dB for example. The second pair, if present, may have a metric n₁ΔdB below the metric of the first pair, where n₁ is signaled. The third pair, if present, may have a metric n₂ΔdB below the metric of the first pair (or alternatively the second pair), where n₂ is signaled, and so on.

In one example, the measurement reports may be configured periodically. In one example, the measurement reports may be configured semi-persistently, with a dynamic signal (e.g., by MAC CE or L1 control) to activate or deactivate the transmission of the measurement report. In one example, the measurement report may be triggered aperiodically using a dynamic signal (e.g., by MAC CE or L1 control). In one example, the measurement report may be UE initiated; for example, the UE may send a scheduling request for UL resources to send the measurement report, or the UE may send the measurement report in a configured grant (Type 1 or Type 2 configured grant) resource or the UE may send the measurement report using a random access procedure (e.g., Type 1 random access procedure or Type 2 random access procedure).

In one example, the measurement reports may be reported in uplink control information (UCI) in a physical uplink control channel (PUCCH). In one example, if the PUCCH overlaps with a physical uplink shared channel (PUSCH), the PUCCH may not be transmitted, and the UCI is multiplexed into the PUSCH. In one example, the measurement reports may be reported in UCI in a PUSCH. In one example, the measurement reports may be reported in MAC CE. In one example, the measurement reports may be reported in a single stage UCI. In another example, the measurement reports may be reported in a two stage UCI. For example, the first stage may include information about the number of measurement pairs (e.g., measurement pairs per cell) or the number of cells with reported measurements, and the measurement pairs are reported in the second stage of the UCI.

At step 1250 of FIG. 12, source cell 1201 determines which TCI states to activate. For example, the TCI states to activate may belong to the source cell or to one or more target (or candidate) cells. In one example, the number of cells with activated TCI states may be limited (e.g., by system specifications and/or by RRC configuration and/or MAC CE signaling and/or L1 control signaling). In one example, the activated TCI states may be on the source cell and an additional target (or candidate) cell. In one example, the activated TCI states may be indicated by MAC CE signaling, wherein MAC CE signaling activates TCI state code points as aforementioned. In one example, some or all of the activated TCI state code points may belong to a target (or candidate) cell. In one example a single code point may be activated and hence applied after a beam application delay.

At step 1260 of FIG. 12, UE 1203 may initiate a handover or may make a decision on handover based on measurements performed at the UE using the measurement reference signals from source cell 1201 and one or more target (or candidate) cells. In one example, the UE initiation of handover may be event-triggered. In one example, the UE initiation of handover may not be event based. In one example, a UE may make a decision to perform or trigger or initiate handover to a target (or candidate) cell if one or more of the activated TCI state code points belong to the target (or candidate) cell. In one example, a UE may make a decision to perform or trigger or initiate handover to a target (or candidate) cell if the UE has been indicated a TCI state and the TCI state is associated with the target (or candidate) cell. In one example, the target (or candidate) cell may be the cell associated with most recently indicated TCI state. In one example, the target (or candidate) cell may be the cell (e.g., other than the serving cell) associated with activated TCI state. In one example, the target (or candidate) cell may be the cell associated with most recently applied TCI state. Wherein, the TCI state code point may be indicated by a DL related DCI Format, wherein the DL related DCI format may be one of DCI Format 1_1 or DCI Format 1_2. The DCI Format may include a “transmission configuration indication” field to indicate a code point of MAC CE activated TCI state code point. In one example, the DCI Format may include a DL assignment. In another example, the DCI Format may not include a DL assignment.

At step 1270 of FIG. 12, to request or preform or trigger or initiate handover, UE 1203 provides a message to the network (this is shown as a measurement report in FIG. 12). In one example, the message may be a measurement report, and the measurement report may include a flag or an information element (IE) that indicates the UE requests or is triggering or is initiating handover to a target (or candidate) cell. The IE may include the target (or candidate) cell index, or the target (or candidate) cell may be implicitly determined (e.g., cell with indicated TCI state or the cell (other than the source cell) with activated TCI states).

In another example, the message may be a measurement report, and the measurement report may only include measurement pairs associated with a target (or candidate) cell. The measurement report may include a flag to indicate that the UE requests or is triggering or is initiating handover to the target (or candidate) cell. Alternatively, there may be no flag and handover may be implicitly determined to the target (or candidate) cell.

In another example the message may be a measurement report, and the measurement report may include measurement pairs associated from multiple cells. The first measurement pair (i.e., the measurement pair with the best metric) may be associated with a target (or candidate) cell. The measurement report may include a flag to indicate that the UE requests or is triggering or is initiating handover to the target (or candidate) cell. Alternatively, there may be no flag and handover may be implicitly determined to the target (or candidate) cell.

In another example, the message may be an information element that includes the target (or candidate) cell for which the UE requests or is triggering or is initiating handover to.

At step 1270 of FIG. 12, the message UE 1203 provides to request or preform or trigger or initiate handover may be sent to source cell 1201 (as shown in FIG. 12) or to target (or candidate) cell 1202. The cell to which the message is sent may be determined by the most recently indicated TCI state to the UE.

In one example, the message UE 1203 provides to request or preform or trigger or initiate handover may be configured periodically. In one example, the message may be configured semi-persistently, with a dynamic signal (e.g., by MAC CE or L1 control) to activate or deactivate the transmission of the message. In one example, the message may be triggered aperiodically using a dynamic signal (e.g., by MAC CE or L1 control). In one example, the message may be UE initiated; for example, the UE may send a scheduling request for UL resources to send the message, or the UE may send the message in a configured grant (Type 1 or Type 2 configured grant) resource, or the UE may send the message using a random access procedure (e.g., Type 1 random access procedure or Type 2 random access procedure).

In one example, the message UE 1203 provides to request or preform or trigger or initiate handover may be reported in uplink control information (UCI) in a physical uplink control channel (PUCCH). In one example, if the PUCCH overlaps with a physical uplink shared channel (PUSCH), the PUCCH may not be transmitted, and the UCI may be multiplexed into the PUSCH. In one example, the message the UE provides to request or preform or trigger or initiate handover may be reported in UCI in a PUSCH. In one example, the message the UE provides to request or preform or trigger or initiate handover may be reported in MAC CE. In one example, the message the UE provides to request or preform or trigger or initiate handover may be reported in MAC CE. In one example, the message may be reported in a single stage UCI. In another example, the message may be reported in a two stage UCI.

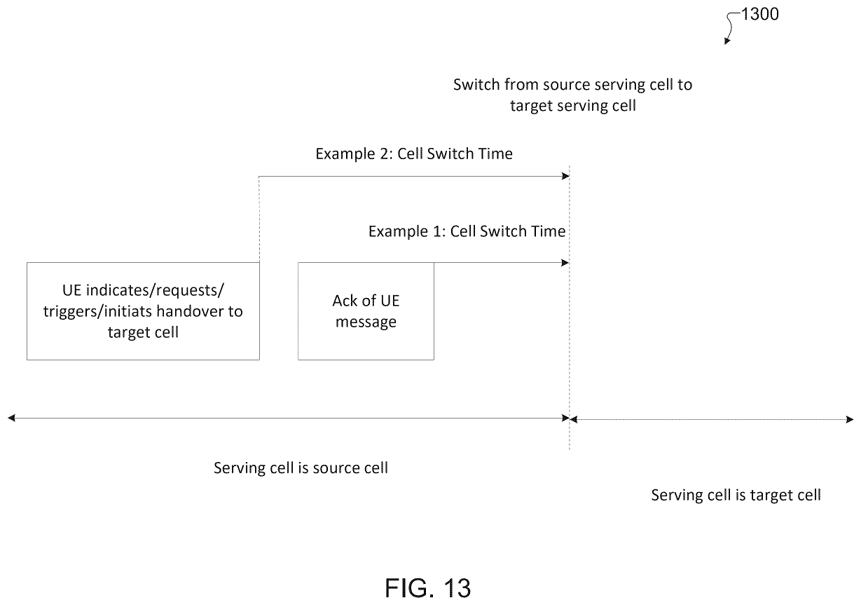

In one example, the message from the UE may trigger a handover to the target (or candidate) cell after a cell switch time (delay) as illustrated in FIG. 13.

FIG. 13 illustrates an example method 1300 of handover to a target (or candidate) cell after a cell switch time according to the present disclosure. The embodiment of the method of handover shown in FIG. 13 is for illustration only. Other embodiments of the method of handover could be used without departing from the scope of this disclosure.

In one example (example 2 in FIG. 13), the cell switch time (delay) may be from the message from the UE indicating or requesting or triggering or initiating handover (this may be on PUCCH or PUSCH (UCI or MAC CE) as aforementioned). The cell switch time may be from the end of the message (Example 2 of FIG. 13) or from the start of the message. In another example (example 1 in FIG. 13), the cell switch time (delay) may be from the acknowledgement of UE message indicating or requesting or triggering or initiating handover. The cell switch time may be from the end of the ACK message (Example 1 of FIG. 13) or from the start of the ACK message. In one example, the ACK message may be a DCI format on PDCCH that the network sends in response to the message from the UE. In another example, the ACK message may be a DL transmission (e.g., PDCCH+PDSCH or MAC CE) that the network sends in response to the message from the UE.

In one example, if the UE requests/triggers/initiates/indicates handover to the network and the latest indicated beam is not on the target (or candidate) cell (e.g., the latest indicated beam is on the source cell), the network may apply a beam on the target (or candidate) cell before or at the same time as the cell switch.

In one example, the network may determine the TCI state of the target (or candidate) cell based on the measurement report and indicate the TCI state to the UE (e.g., as described in FIG. 8). The cell switch may occur at the time TCI state of the target (or candidate) cell is applied (e.g., as indicated in FIG. 9).

In one example, the TCI state of the target (or candidate) cell may be determined by the UE and indicated in the message requesting/triggering/initiating/indicating handover from the UE. The TCI state indicated by the UE may be applied at the time of cell switch for example as illustrated in FIG. 13.

In one example, the TCI state of the target (or candidate) cell may be determined by the UE in the measurement report. The TCI state associated with the strongest measurement pair from the target (or candidate) cell may be used. In one example, TCI state based on, e.g., the strongest pair in the measurement report may be indicated to the UE and the cell switch time may follow FIG. 8 and FIG. 9. In one example, the TCI state may be implicitly determined without further signaling from the network based on the strongest pair associated with the target (or candidate) cell in the measurement report from the UE and the corresponding TCI state may be applied at the cell switch time e.g., as illustrated in FIG. 13.

Although FIG. 13 illustrates one example of a method 1300 of handover to a target (or candidate) cell after a cell switch time, various changes may be made to FIG. 13. For example, while shown as a series of steps, various steps in FIG. 13 could overlap, occur in parallel, occur in a different order, or occur any number of times.

At step 1270a of FIG. 12 information is exchanged between source cell 1201 and target (or candidate) cell 1202 to complete the handover at the cell switch time.

Although FIG. 12 illustrates one example of a method 1200 of handover based on UE initiation, various changes may be made to FIG. 12. For example, while shown as a series of steps, various steps in FIG. 12 could overlap, occur in parallel, occur in a different order, or occur any number of times.

In one embodiment dynamic switch of a serving cell is based on UE initiation.

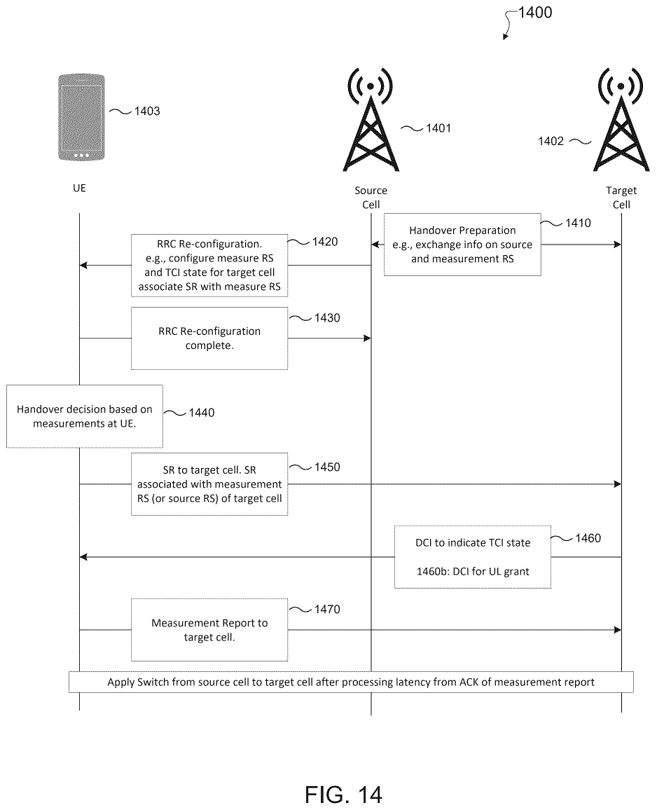

FIG. 14 illustrates an example method 1400 of handover based on UE initiation according to the present disclosure. An embodiment of the method illustrated in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments of the method of handover could be used without departing from the scope of this disclosure.

At step 1410 of FIG. 14, handover preparation occurs between source cell 1401 and target (or candidate) cell 1402. Source cell 1401 may be a serving cell associated with a physical cell identity (PCI). Target (or candidate) cell 1402 may be a second cell associated with a PCI different from the PCI of the serving cell (source cell). There may be one or more target (or candidate) cells, and each target (or candidate) cell may have its own PCI. In one example, if there is more than one target (or candidate) cell, each target (or candidate) cell may have a PCI different from the PCI of other target (or candidate) cells. In one example, if there is more than one target (or candidate) cell, each target (or candidate) cell may have a PCI that is the same as the PCI of the other target (or candidate) cells. In one example, if there is more than one target (or candidate) cell, each subset of target (or candidate) cells may have a PCI that is the same as the PCI of the other target (or candidate) cells in the same subset, while other subsets of target (or candidate) cells may have different PCIs.

In one example, the handover preparation may include exchange of reference signals between cells involved in the potential handover. For example, the reference signals may be measurement reference signals, wherein the measurement reference signals are used for measurement reports from the UE. The measurement signals may be used for example, to identify new candidate beams in the serving (e.g., source cell) or in a target (or candidate) cell(s). The measurement signals may be used for example to determine if handover should be triggered or performed from the source cell to a target (or candidate) cell. The measurement metric on the measurement reference signal may be L1-reference signal receive power (L1-RSRP), signal to interference and noise ratio (SINR) derived based on the measurement reference signal, block error rate (BLER), channel quality indicator (CQI), L3-RSRP, wherein the L3-RSRP is a long term averaged (e.g., exponential averaging) of the L1-RSRP, or some other quality metric determined based on the measurement reference signal. Measurement reference signals may include DL measurement reference signals transmitted from the network (e.g., gNB or TRP of source cell or target (or candidate) cell(s)), wherein the measurement may be performed in the UE and reported to the network in a measurement report. Measurement reference signals may include UL measurement reference signals (e.g., SRS) transmitted by the UE, wherein the measurement is performed in the network (e.g., gNB or TRP of source cell or target (or candidate) cell(s)). In one example, a measurement reference signal is used as a source reference signal.

In another example, the reference signals may be source reference signals, wherein the source reference signals are used in the TCI state to determine the source of a quasi-colocation (QCL) (e.g., the source RS for QCL-TypeA, or QCL-TypeB or QCL-TypeC or QCL-TypeD); or to determine the source of the spatial relation (e.g., to determine a spatial relation receive filter or a spatial relation transmit filter). Source reference signals may include DL reference signals transmitted from the network (e.g., gNB or TRP of source cell or target (or candidate) cell(s)). Source reference signals may include UL reference signals (e.g., SRS) transmitted by the UE. In one example, a source reference signal is used as a measurement reference signal.

In one example, the reference signal (e.g., measurement reference signal or source reference signal) may be a Synchronization Signal Block (SSB) (synchronization signal/physical broadcast channel (PBCH) Block), wherein the SSB may be associated with a PCI of a serving cell (e.g., source cell), or a PCI of a cell that is different from the PCI of the serving cell (e.g., a target (or candidate) cell). In one example, the association may be by inclusion of a PCI in the configuration of SSB resource or the information element (IE) including the SSB resource. In another example, the association may be by configuration of the SSB resource as part of the configuration of the cell associated with the PCI.

In another example, the reference signal may be Channel state information-reference signal (CSI-RS). The CSI-RS may be for example, CSI-RS for mobility (e.g., used for handover), or CSI-RS for beam management or CSI-RS for tracking or CSI-RS for CSI acquisition. The CSI-RS may be associated with a PCI of a serving cell (e.g., source cell), or a PCI of a cell that is different from the PCI of the serving cell (e.g., a target (or candidate) cell). In one example, the association may be through a QCL relation with an SSB, or CSI-RS associated with a PCI of a cell. In another example, the association may be by inclusion of a PCI in the configuration of CSI-RS resource or the information element (IE) including the CSI-RS resource. In another example, the association may be by configuration of the CSI-RS resource as part of the configuration of the cell associated with the PCI.

In another example, the reference signal may be a sounding reference signal (SRS), wherein the SRS is transmitted by the UE. In one example, the SRS may be an SRS resource for beam management. In another example, the SRS may be an SRS resource for codebook. In another example, the SRS may be an SRS resource for non-codebook. In another example, the SRS may be an SRS resource for antenna switching. In another example, the SRS may be an SRS resource for mobility (e.g., used for handover). In one example, the SRS may be associated with a PCI of a serving cell (e.g., source cell), or a PCI of a cell that is different from the PCI of the serving cell (e.g., a target (or candidate) cell). In one example, the SRS is not associated with a PCI of a cell (e.g., the SRS may be transmitted by the UE and may be received by any cell). In one example, the association may be through a QCL relation or a spatial relation with an SSB or CSI-RS or SRS associated with a PCI of a cell. In another example, the association may be by inclusion of a PCI in the configuration of SRS resource or the information element (IE) including the SRS resource. In another example, the association may be by configuration of the SRS resource as part of the configuration of the cell associated with the PCI.

In one example, the handover preparation may include exchange of transmission configuration indication (TCI) states between cells involved in the potential handover. For example, the TCI state may include a DL or Joint TCI state (DLorJoint-TCIState) that includes for example one or more of: (1) TCI state ID; (2) first QCL info; (3) second QCL info; (4) UL power control ID; (5) path loss reference signal ID; and (6) associated PCI (alternatively, the associated PCI may be included in the QCL Info). The QCL-Info may include (1) serving cell index; (2) BWP ID; (3) reference signal ID (e.g., CSI-RS resource ID or SSB-Index); (4) QCL Type (e.g., typeA, typeB, typeC, or typeD); and (5) PCI index, alternatively the PCI Index may be part of the reference signal ID.

In another example, the TCI state may include a UL TCI state (UL-TCIState) that includes for example one or more of: (1) TCI state ID; (2) serving cell index; (3) reference signal ID (e.g., CSI-RS resource ID or SSB-Index or SRS resource ID); (4) PCI index, alternatively the PCI Index may be part of the reference signal ID; (5) UL power control ID; and (6) path loss reference signal ID.

In one example, the handover preparation may include association of measurement reference signal of a target (or candidate) cell, with scheduling request resources of the target (or candidate) cell. For example, RS0 may be associated with SR0, and RS1 may associated with SR1. When a UE determines RS0 as the preferred measurement RS on the target (or candidate) cell, it may send a scheduling request in the associated SR resource.

At step 1420 of FIG. 14, the network performs RRC (re-) configuration towards UE 1403. For example, a reconfiguration message may include information related to one or more target (or candidate) cells. In one example, the information may include reference signals of target (or candidate) cell(s); e.g., measurement reference signals or source reference signals as aforementioned. In another example, the information may include TCI states of target (or candidate) cell(s) as aforementioned. In another example, the information may include association of measurement RS with scheduling request resources of a target (or candidate) cell as aforementioned.

At step 1430 of FIG. 14, UE 1403 responds with RRC (re-) configuration complete.

At step 1440 of FIG. 14, UE 1403 may initiate a handover or may make a decision on handover based on measurements performed at the UE using the measurement reference signals from the source cell and one or more target (or candidate) cells. In one example, the UE initiation of handover may be event-triggered. In one example, the UE initiation of handover may not be event based.

At step 1450 of FIG. 14, UE 1403 sends a scheduling request (SR) to target (or candidate) cell 1402 that is associated with the preferred measurement RS of the target (or candidate) cell. The resource of the SR may be an implicit indication of the preferred beam to use from the target (or candidate) cell.

At step 1460 of FIG. 14, the network may optionally indicate a TCI state based on the preferred beam associated with the SR from the UE. The indication may be from the target (or candidate) cell using a beam for the DCI used beam indication following the preferred beam of the SR resource. Alternatively, the indication may be from the source cell using the most recently indicated TCI state. In one example, the indication of the TCI state may be by a MAC CE from the target cell. In one example, the indication of the TCI state may be by a MAC CE from the source cell. The network may optionally not indicate a TCI state. Instead, the TCI state may be determined implicitly to be that associated with the SR resource used by the UE. The corresponding beam application time may be after a processing delay from end (or alternatively start) of the SR resource. At step 1460b the network may send an uplink grant for the UE to report the beam measurement report. In one example, the UL grant may be in a MAC CE (e.g., from the source cell or the target cell). In one example, the UL grant may be in a same MAC CE as that used to indicate a TCI state.

At step 1470 of FIG. 14, the measurement report is sent from UE 1403 to the network, e.g., using the resources provided by the UL grant of step 1460b. In one example, a measurement report may be sent by the UE and acknowledgment handover from the source cell to the target (or candidate) cell occurs with no additional signaling. In another example, the network may signal the UE to switch target (or candidate) cells as illustrated in FIG. 10 and FIG. 11.

Although FIG. 14 illustrates one example of a method 1400 of handover based on UE initiation, various changes may be made to FIG. 14. For example, while shown as a series of steps, various steps in FIG. 14 could overlap, occur in parallel, occur in a different order, or occur any number of times.

In one embodiment dynamic switch of serving cell is based on UE initiation.

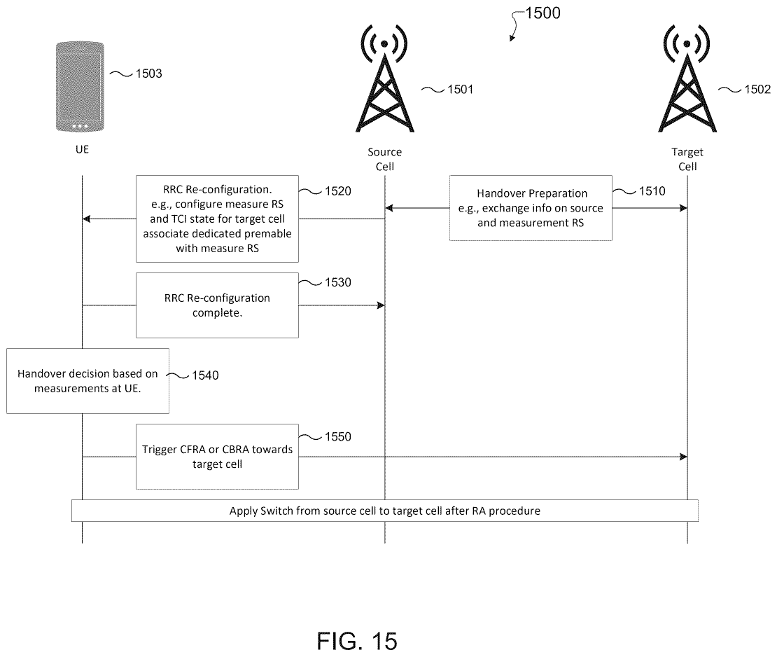

FIG. 15 illustrates an example method 1500 of handover based on UE initiation. according to the present disclosure. An embodiment of the method illustrated in FIG. 15 is for illustration only. One or more of the components illustrated in FIG. 15 may be implemented in specialized circuitry configured to perform the noted functions or one or more of the components may be implemented by one or more processors executing instructions to perform the noted functions. Other embodiments of the method of handover could be used without departing from the scope of this disclosure.

At step 1510 of FIG. 15, handover preparation occurs between source cell 1501 and target (or candidate) cell 1502. Source cell 1502 may be a serving cell associated with a physical cell identity (PCI). Target (or candidate) cell 1502 may be a second cell associated with a PCI different from the PCI of serving cell 1501 (source cell). There may be one or more target (or candidate) cells, and each target (or candidate) cell may have its own PCI. In one example, if there is more than one target (or candidate) cell, each target (or candidate) cell may have a PCI different from the PCI of other target (or candidate) cells. In one example, if there is more than one target (or candidate) cell, each target (or candidate) cell may have a PCI that is the same as the PCI of the other target (or candidate) cells. In one example, if there is more than one target (or candidate) cell, each subset of target (or candidate) cells may have a PCI that is the same as the PCI of the other target (or candidate) cells in the same subset, while other subsets of target (or candidate) cells may have different PCIs.

In one example, the handover preparation may include exchange of reference signals between cells involved in the potential handover. For example, the reference signals may be measurement reference signals, wherein the measurement reference signals are used for measurement reports from the UE. The measurement signals may be used for example, to identify new candidate beams in the serving (e.g., source cell) or in a target (or candidate) cell(s). The measurement signals may be used for example to determine if handover should be triggered or performed from the source cell to a target (or candidate) cell. The measurement metric on the measurement reference signal may be L1-reference signal receive power (L1-RSRP), signal to interference and noise ratio (SINR) derived based on the measurement reference signal, block error rate (BLER), channel quality indicator (CQI), L3-RSRP, wherein the L3-RSRP is a long term averaged (e.g., exponential averaging) of the L1-RSRP, or some other quality metric determined based on the measurement reference signal. Measurement reference signals may include DL measurement reference signals transmitted from the network (e.g., gNB or TRP of source cell or target (or candidate) cell(s)), wherein the measurement may be performed in the UE and reported to the network in a measurement report. Measurement reference signals may include UL measurement reference signals (e.g., SRS) transmitted by the UE, wherein the measurement is performed in the network (e.g., gNB or TRP of source cell or target (or candidate) cell(s)). In one example, a measurement reference signal may be used as a source reference signal.

In another example, the reference signals may be source reference signals, wherein the source reference signals are used in the TCI state to determine the source of a quasi-colocation (QCL) (e.g., the source RS for QCL-TypeA, or QCL-TypeB or QCL-TypeC or QCL-TypeD); or to determine the source of the spatial relation (e.g., to determine a spatial relation receive filter or a spatial relation transmit filter). Source reference signals may include DL reference signals transmitted from the network (e.g., gNB or TRP of source cell or target (or candidate) cell(s)). Source reference signals may include UL reference signals (e.g., SRS) transmitted by the UE.

The reference signal (e.g., measurement reference signal or source reference signal) may be a Synchronization Signal Block (SSB) (synchronization signal/physical broadcast channel (PBCH) Block), wherein the SSB may be associated with a PCI of a serving cell (e.g., source cell), or a PCI of a cell that is different from the PCI of the serving cell (e.g., a target (or candidate) cell). In one example, the association may be by inclusion of a PCI in the configuration of SSB resource or the information element (IE) including the SSB resource. In another example, the association may be by configuration of the SSB resource as part of the configuration of the cell associated with the PCI.

In another example, the reference signal may be a channel state information-reference signal (CSI-RS). The CSI-RS may be for example, CSI-RS for mobility (e.g., used for handover), or CSI-RS for beam management or CSI-RS for tracking or CSI-RS for CSI acquisition. The CSI-RS may be associated with a PCI of a serving cell (e.g., source cell), or a PCI of a cell that is different from the PCI of the serving cell (e.g., a target (or candidate) cell). In one example, the association may be through a QCL relation with an SSB, or CSI-RS associated with a PCI of a cell. In another example, the association may be by inclusion of a PCI in the configuration of CSI-RS resource or the information element (IE) including the CSI-RS resource. In another example, the association may be by configuration of the CSI-RS resource as part of the configuration of the cell associated with the PCI.

In another example, the reference signal may be a sounding reference signal (SRS), wherein the SRS is transmitted by the UE. In one example, the SRS may be an SRS resource for beam management. In another example, the SRS may be an SRS resource for codebook. In another example, the SRS may be an SRS resource for non-codebook. In another example, the SRS may be an SRS resource for antenna switching. In another example, the SRS may be an SRS resource for mobility (e.g., used for handover). In one example, the SRS may be associated with a PCI of a serving cell (e.g., source cell), or a PCI of a cell that is different from the PCI of the serving cell (e.g., a target (or candidate) cell). In one example, the SRS may not be associated with a PCI of a cell (e.g., the SRS may be transmitted by the UE and may be received by any cell). In one example, the association may be through a QCL relation or a spatial relation with an SSB or CSI-RS or SRS associated with a PCI of a cell. In another example, the association may be by inclusion of a PCI in the configuration of SRS resource or the information element (IE) including the SRS resource. In another example, the association may be by configuration of the SRS resource as part of the configuration of the cell associated with the PCI.

In one example, the handover preparation may include exchange of transmission configuration indication (TCI) states between cells involved in the potential handover. For example, the TCI state may include a DL or joint TCI state (DLorJoint-TCIState) that includes for example one or more of: (1) TCI state ID; (2) first QCL info; (3) second QCL info; (4) UL power control ID; (5) path loss reference signal ID; and (6) associated PCI (alternatively, the associated PCI may be included in the QCL Info). The QCL-Info may include (1) serving cell index; (2) BWP ID; (3) reference signal ID (e.g., CSI-RS resource ID or SSB-Index); (4) QCL Type (e.g., typeA, typeB, typeC, or typeD); and (5) PCI index, alternatively the PCI Index may be part of the reference signal ID.

In another example, the TCI state may include a UL TCI state (UL-TCIState) that includes for example one or more of: (1) TCI state ID; (2) serving cell index; (3) reference signal ID (e.g., CSI-RS resource ID or SSB-Index or SRS resource ID); (4) PCI index, alternatively the PCI Index may be part of the reference signal ID; (5) UL power control ID; and (6) path loss reference signal ID.

In one example, the handover preparation may include association of measurement reference signal of a target (or candidate) cell, with dedicated preamble resources of the target (or candidate) cell. For example, RS0 may be associated with Preamble0, and RS1 may be associated with Preamble1. When a UE determines RS0 as the preferred measurement RS on the target (or candidate) cell, it may initiate a random access procedure using the associated preamble.

At step 1520 of FIG. 15, the network performs RRC (re-) configuration towards UE 1503. For example, a reconfiguration message may include information related to one or more target (or candidate) cells. In one example, the information may include reference signals of target (or candidate) cell(s); e.g., measurement reference signals or source reference signals as aforementioned. In another example, the information may include TCI states of target (or candidate) cell(s) as aforementioned. In another example, the information may include Association of measurement RS with preamble resources of a target (or candidate) cell as aforementioned.

At step 1530 of FIG. 15, UE 1503 responds with RRC (re-) configuration complete.

At step 1540 of FIG. 15, UE 1503 may initiate a handover or may make a decision on handover based on measurements performed at the UE using the measurement reference signals from the source cell and one or more target (or candidate) cells. In one example, the UE initiation of handover may be event-triggered. In one example, the UE initiation of handover may not be event based.

At step 1540 of FIG. 15, UE 1503 triggers a random access procedure. In one example, the random access procedure triggered may be a type 1 random access procedure (e.g., 4-step RACH). In another example, the random access procedure triggered may be a type 2 random access procedure (e.g., 2-step RACH). In another example, the random access procedure may be a contention-based random access procedure. In another example, the random access procedure may be a contention-free random access procedure, e.g., the UE may use dedicated preambles, wherein a preamble may be associated with a measurement RS as aforementioned. The UE may send a preamble to the target (or candidate) cell that is associated with the preferred measurement RS of the target (or candidate) cell. The preamble may be an implicit indication of the preferred beam to use from the target (or candidate) cell. In one example, during a RACH procedure, the UE may convey a beam measurement report.

After the random access procedure, the handover procedure from source cell 1501 to target (or candidate) cell 1503 is completed. In one example, after random access procedure is complete handover from the source cell to the target (or candidate) cell may occur with no additional signaling. In another example, the network may signal the UE to switch target (or candidate) cells as illustrated in FIG. 10 and FIG. 11.

Although FIG. 15 illustrates one example of a method 1500 of handover based on UE initiation, various changes may be made to FIG. 15. For example, while shown as a series of steps, various steps in FIG. 15 could overlap, occur in parallel, occur in a different order, or occur any number of times.

In one embodiment, dynamic switch of serving cell is based on UE initiation.

FIG. 16 illustrates an example method 1600 of handover based on UE initiation according to the present disclosure. An embodiment of the method illustrated in FIG. 16 is for illustration only. One or more of the components illustrated in FIG. 16 may be implemented in specialized circuitry configured to perform the noted functions or one or more of the components may be implemented by one or more processors executing instructions to perform the noted functions. Other embodiments of the method of handover could be used without departing from the scope of this disclosure.

Step 1610 of FIG. 16, handover preparation occurs between source cell 1601 and target (or candidate) cell 1602. Source cell 1601 may be a serving cell associated with a physical cell identity (PCI). Target (or candidate) cell 1602 may be a second cell associated with a PCI different from the PCI of serving cell 1601 (source cell). There may be one or more target (or candidate) cells, and each target (or candidate) cell may have its own PCI. In one example, if there is more than one target (or candidate) cell, each target (or candidate) cell may have a PCI different from the PCI of other target (or candidate) cells. In one example, if there is more than one target (or candidate) cell, each target (or candidate) cell may have a PCI that is the same as the PCI of the other target (or candidate) cells. In one example, if there is more than one target (or candidate) cell, each subset of target (or candidate) cells may have a PCI that is the same as the PCI of the other target (or candidate) cells in the same subset, while other subsets of target (or candidate) cells may have different PCIs.

In one example, the handover preparation may include exchange of reference signals between cells involved in the potential handover. For example, the reference signals may be measurement reference signals, wherein the measurement reference signals are used for measurement reports from the UE. The measurement signals may be used for example, to identify new candidate beams in the serving (e.g., source cell) or in a target (or candidate) cell(s). The measurement signals may be used for example to determine if handover should be triggered or performed from the source cell to a target (or candidate) cell. The measurement metric on the measurement reference signal may be L1-reference signal receive power (L1-RSRP), signal to interference and noise ratio (SINR) derived based on the measurement reference signal, block error rate (BLER), channel quality indicator (CQI), L3-RSRP, wherein the L3-RSRP is a long term averaged (e.g., exponential averaging) of the L1-RSRP, or some other quality metric determined based on the measurement reference signal. Measurement reference signals may include DL measurement reference signals transmitted from the network (e.g., gNB or TRP of source cell or target (or candidate) cell(s)), wherein the measurement may be performed in the UE and reported to the network in a measurement report. Measurement reference signals may include UL measurement reference signals (e.g., SRS) transmitted by the UE, wherein the measurement is performed in the network (e.g., gNB or TRP of source cell or target (or candidate) cell(s)). In one example, a measurement reference signal may be used as a source reference signal.

In another example, the reference signals may be source reference signals, wherein the source reference signals are used in the TCI state to determine the source of a quasi-colocation (QCL) (e.g., the source RS for QCL-TypeA, or QCL-TypeB or QCL-TypeC or QCL-TypeD); or to determine the source of the spatial relation (e.g., to determine a spatial relation receive filter or a spatial relation transmit filter). Source reference signals may include DL reference signals transmitted from the network (e.g., gNB or TRP of source cell or target (or candidate) cell(s)). Source reference signals may include UL reference signals (e.g., SRS) transmitted by the UE. In one example, a source reference signal may be used as a measurement reference signal.

In one example, the reference signal (e.g., measurement reference signal or source reference signal) may be a Synchronization Signal Block (SSB) (synchronization signal/physical broadcast channel (PBCH) Block), wherein the SSB may be associated with a PCI of a serving cell (e.g., source cell), or a PCI of a cell that is different from the PCI of the serving cell (e.g., a target (or candidate) cell). In one example, the association may be by inclusion of a PCI in the configuration of SSB resource or the information element (IE) including the SSB resource. In another example, the association may be by configuration of the SSB resource as part of the configuration of the cell associated with the PCI.

In another example, the reference signal may be a channel state information-reference signal (CSI-RS). The CSI-RS may be for example, CSI-RS for mobility (e.g., used for handover), or CSI-RS for beam management or CSI-RS for tracking or CSI-RS for CSI acquisition. The CSI-RS may be associated with a PCI of a serving cell (e.g., source cell), or a PCI of a cell that is different from the PCI of the serving cell (e.g., a target (or candidate) cell). In one example, the association may be through a QCL relation with an SSB, or CSI-RS associated with a PCI of a cell. In another example, the association may be by inclusion of a PCI in the configuration of CSI-RS resource or the information element (IE) including the CSI-RS resource. In another example, the association may be by configuration of the CSI-RS resource as part of the configuration of the cell associated with the PCI.

In another example, the reference signal may be a sounding reference signal (SRS), wherein the SRS is transmitted by the UE. In one example, the SRS may be an SRS resource for beam management. In another example, the SRS may be an SRS resource for codebook. In another example, the SRS may be an SRS resource for non-codebook. In another example, the SRS may be an SRS resource for antenna switching. In another example, the SRS may be an SRS resource for mobility (e.g., used for handover). In one example, the SRS may be associated with a PCI of a serving cell (e.g., source cell), or a PCI of a cell that is different from the PCI of the serving cell (e.g., a target (or candidate) cell). In one example, the SRS is not associated with a PCI of a cell (e.g., the SRS may be transmitted by the UE and may be received by any cell). In one example, the association may be through a QCL relation or a spatial relation with an SSB or CSI-RS or SRS associated with a PCI of a cell. In another example, the association may be by inclusion of a PCI in the configuration of SRS resource or the information element (IE) including the SRS resource. In another example, the association may be by configuration of the SRS resource as part of the configuration of the cell associated with the PCI.

In one example, the handover preparation may include exchange of transmission configuration indication (TCI) states between cells involved in the potential handover. For example, the TCI state may include a DL or Joint TCI state (DLorJoint-TCIState) that includes for example one or more of: (1) TCI state ID; (2) first QCL info; (3) second QCL info; (4) UL power control ID; (5) path loss reference signal ID; and (6) associated PCI (alternatively, the associated PCI may be included in the QCL Info). The QCL-Info may include (1) serving cell index; (2) BWP ID; (3) reference signal ID (e.g., CSI-RS resource ID or SSB-Index); (4) QCL Type (e.g., typeA, typeB, typeC, or typeD); and (5) PCI index, alternatively the PCI Index may be part of the reference signal ID.

In another example, the TCI state may include a UL TCI state (UL-TCIState) that includes for example one or more of: (1) TCI state ID; (2) serving cell index; (3) reference signal ID (e.g., CSI-RS resource ID or SSB-Index or SRS resource ID); (4) PCI index, alternatively the PCI Index may be part of the reference signal ID; (5) UL power control ID; and (6) path loss reference signal ID.

At step 1620 of FIG. 16, the network performs RRC (re-) configuration towards UE 1603. For example, a reconfiguration message may include information related to one or more target (or candidate) cells. For example, the information may include one or more of reference signals of target (or candidate) cell(s) (e.g., measurement reference signals or source reference signals as aforementioned) or TCI states of target (or candidate) cell(s) as aforementioned.

At step 1630 of FIG. 16, UE 1603 responds with RRC (re-) configuration complete.

At step 1640 of FIG. 16, UE 1603 performs measurements on the configured measurement reference signals of the source cell and one or more target (or candidate) cell(s). UE 1620 may provide a measurement report to the source cell. The measurement report may include one or more pairs of (1) measurement reference signal ID (e.g., of the source cell or of a target (or candidate) cell); (2) quality metric (e.g., L1-RSRP, SINR, BLER, CQI, L3-RSRP, as aforementioned). The measurement report may include measurements from the source cell only, or from a target (or candidate) cell only, or from the source cell and a target (or candidate) cell, or from one or more target (or candidate) cells, or from a source cell and one or more target (or candidate) cells. The number of cells in a measurement report may be limited (e.g., by system specifications and/or by RRC configuration and/or MAC CE signaling and/or L1 control signaling). The number of measurement pairs (e.g., measurement pairs per cell) in a measurement report may be limited (e.g., by system specifications and/or by RRC configuration and/or MAC CE signaling and/or L1 control signaling). L1 control signaling may be a DL control information (DCI) signal. When multiple measurement pairs are reported, differential signaling (reporting) may be used, for example, metric of the first pair (e.g., first pair in measurement report or first pair associated with a cell in a measurement report) is an absolute value, this is the pair with the best beam metric (e.g., in the measurement report or per cell in the measurement report), other pairs (e.g., across all cells or per cell) in the same report are relative to the metric of the first pair (e.g., first pair in measurement report or first pair associated with a cell in a measurement report) (or alternatively the metric of the previous pair) with a step size of A dB for example. The second pair, if present, may have a metric n₁ΔdB below the metric of the first pair, where n₁ is signaled. The third pair, if present, may have a metric n₂ΔdB below the metric of the first pair (or alternatively the second pair), where n₂ is signaled, and so on.

In one example, the measurement reports may be configured periodically. In one example, the measurement reports may be configured semi-persistently, with a dynamic signal (e.g., by MAC CE or L1 control) to activate or deactivate the transmission of the measurement report. In one example, the measurement report may be triggered aperiodically using a dynamic signal (e.g., by MAC CE or L1 control). In one example, the measurement report may be UE initiated; for example, the UE may send a scheduling request for UL resources to send the measurement report, or the UE may send the measurement report in a configured grant (Type 1 or Type 2 configured grant) resource or the UE may send the measurement report using a random access procedure (e.g., Type 1 random access procedure or Type 2 random access procedure).

In one example, the measurement reports may be reported in uplink control information (UCI) in a physical uplink control channel (PUCCH). In one example, if the PUCCH overlaps with a physical uplink shared channel (PUSCH), the PUCCH may not be transmitted, and the UCI is multiplexed into the PUSCH. In one example, the measurement reports may be reported in UCI in a PUSCH. In one example, the measurement reports may be reported in MAC CE. In one example, the measurement reports may be reported in a single stage UCI. In another example, the measurement reports may be reported in a two stage UCI. For example, the first stage may include information about the number of measurement pairs (e.g., measurement pairs per cell) or the number of cells with reported measurements, and the measurement pairs may be reported in the second stage of the UCI.

At step 1650 of FIG. 16, source cell 1601 may determine which TCI states to activate. For example, the TCI states to activate may belong to the source cell or to one or more target (or candidate) cells. In one example, the number of cells with activated TCI states may be limited (e.g., by system specifications and/or by RRC configuration and/or MAC CE signaling and/or L1 control signaling). In one example, the activated TCI states may be on the source cell and an additional target (or candidate) cell. In one example, the activated TCI states are indicated by MAC CE signaling, wherein MAC CE signaling activates TCI state code points as aforementioned. In one example, some or all of the activated TCI state code points belong to a target (or candidate) cell. In one example a single code point is activated and hence applied after a beam application delay.

At step 1660 of FIG. 16, TCI state code points are indicated to UE 1603. The TCI state code point may be indicated by a DL related DCI Format, wherein the DL related DCI format may be one of DCI Format 1_1 or DCI Format 1_2. The DCI Format may include a “transmission configuration indication” field to indicate a code point of MAC CE activated TCI state code point. In one example, the DCI Format may include a DL assignment. In another example, the DCI Format may not include a DL assignment. In one example, the indicated TCI state code point may belong to a cell with a PCI different from the PCI of the serving cell. This may be a target (or candidate) cell. In one example, the TCI state code point may be indicated in a MAC CE as illustrated in FIG. 16. In one example, multiple TCI state code points may be indicated.

In one example, as illustrated in FIG. 16, UE 1603 may be indicated two TCI states one for source cell and one for target (or candidate) cell (M=2, N=2). The network may determine the TCI state of the target (or candidate) cell based on the measurement reports from the UE. Mis the number of DL TCI states indicated to the UE and N is the number of UL TCI state indicated to the UE. The UE selects one of the UL or joint TCI states for UL transmission of measurement report (Step 8 of FIG. 16) to network (source cell or target (or candidate) cell). If measurement report sent to target (or candidate) cell, subsequent DL receptions and UL transmissions may be performed using the TCI state of the target (or candidate) cell. Handover may be decided by UE (step 7 of FIG. 16) (sending measurement report to target), or by the target (or candidate) cell, indicator (DCI or MAC CE) sent from target (or candidate) cell to UE for handover.

In one example, the UE may be indicated two UL TCI states one for source cell and one for target (or candidate) cell (M=1, N=2). M is the number of DL TCI states indicated to the UE and N is the number of UL TCI state indicated to the UE. The UE selects one of the UL TCI states for UL transmission of measurement report to network (source cell or target (or candidate) cell). If measurement report sent to target (or candidate) cell, target (or candidate) cell may decide whether to perform handover. Handover command to UE (MAC CE or DCI) sent from source cell. Handover command may indicate TCI state of target (or candidate) cell (as illustrated in FIG. 8 and FIG. 9).

In one example, the UE may select one of the activated UL TCI states for UL transmission of measurement report to target (or candidate) cell. When measurement report sent to target (or candidate) cell, target (or candidate) cell may decide whether to perform handover. Handover command to UE (MAC CE or DCI) sent from source cell. Handover command may indicate TCI state of target (or candidate) cell (as illustrated in FIG. 8 and FIG. 9).

At step 1670 of FIG. 16, UE 1603 may initiate a handover or may make a decision on handover based on measurements performed at the UE using the measurement reference signals from the source cell and one or more target (or candidate) cells. In one example, the UE initiation of handover may be event-triggered. In one example, the UE initiation of handover may not be event based.

At step 1680 of FIG. 16, to request or preform or trigger or initiate handover, UE 1620 provides a message to the network (this is shown as a measurement report in FIG. 16). In one example the message may be a measurement report, and the measurement report may include a flag or an information element (IE) that indicates the UE requests or is triggering or is initiating handover to a target (or candidate) cell. The IE may include the target (or candidate) cell index, or the target (or candidate) cell may be implicitly determined (e.g., cell with indicated TCI state or the cell (other than the source cell) with activated TCI states. In another example, the message may be a measurement report, and the measurement report may only include measurement pairs associated with a target (or candidate) cell. The measurement report may include a flag to indicate that the UE requests or is triggering or is initiating handover to the target (or candidate) cell. Alternatively, there may be no flag and handover is implicitly determined to the target (or candidate) cell. In another example, the message is a measurement report, and the measurement report may include measurement pairs associated from multiple cells. The first measurement pair (i.e., the measurement pair with the best metric) may be associated with a target (or candidate) cell. The measurement report may include a flag to indicate that the UE requests or is triggering or is initiating handover to the target (or candidate) cell. Alternatively, there may be no flag and handover is implicitly determined to the target (or candidate) cell. In another example, the message may be an information element that includes the target (or candidate) cell for which the UE requests or is triggering or is initiating handover to.

At step 1680 of FIG. 16, the message UE 1603 provides to request or preform or trigger or initiate handover may be sent to the target (or candidate) cell. In one example, the message the UE provides to request or preform or trigger or initiate handover may be configured periodically. In one example, the message may be configured semi-persistently, with a dynamic signal (e.g., by MAC CE or L1 control) to activate or deactivate the transmission of the message. In one example, the message may be triggered aperiodically using a dynamic signal (e.g., by MAC CE or L1 control). In one example, the message may be UE initiated; for example, the UE may send a scheduling request for UL resources to send the message, or the UE may send the message in a configured grant (Type 1 or Type 2 configured grant) resource, or the UE may send the message using a random access procedure (e.g., Type 1 random access procedure or Type 2 random access procedure).

In one example, the message the UE provides to request or preform or trigger or initiate handover may be reported in uplink control information (UCI) in a physical uplink control channel (PUCCH). In one example, if the PUCCH overlaps with a physical uplink shared channel (PUSCH), the PUCCH may not be transmitted, and the UCI may be multiplexed into the PUSCH. In one example, the message the UE provides to request or preform or trigger or initiate handover may be reported in UCI in a PUSCH. In one example, the message the UE provides to request or preform or trigger or initiate handover may be reported in MAC CE. In one example, the message may be reported in a single stage UCI. In another example, the message may be reported in a two stage UCI.

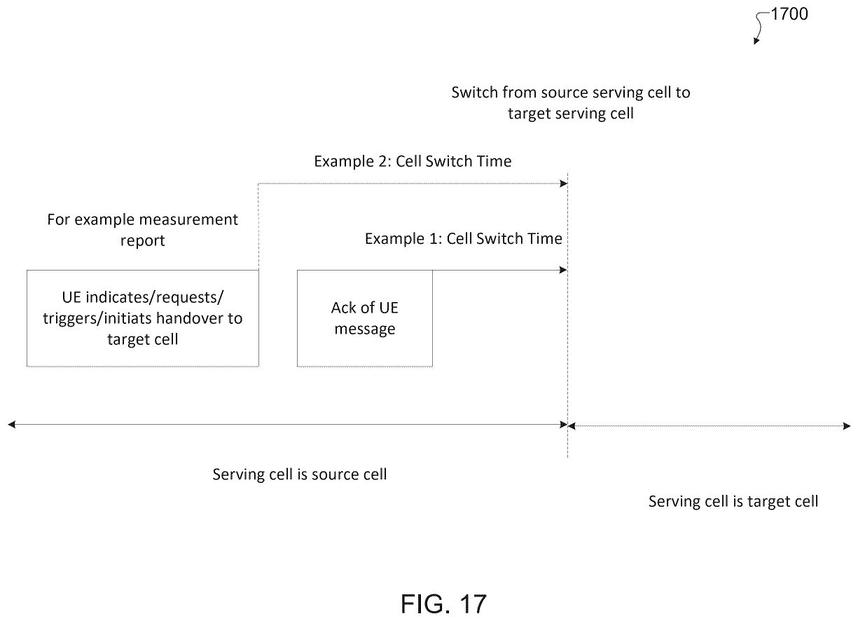

In one example, the message from the UE (e.g., measurement report) triggers a handover to the target (or candidate) cell after a cell switch time (delay) as illustrated in FIG. 17.

FIG. 17 illustrates an example method 1700 for a handover to the target (or candidate) cell after a cell switch time according to the present disclosure. The embodiment method of handover shown in FIG. 17 is for illustration only. Other embodiments of the method of handover could be used without departing from the scope of this disclosure.

Although FIG. 17 illustrates one example of a method 1700 for a handover to the target (or candidate) cell after a cell switch time, various changes may be made to FIG. 17. For example, while shown as a series of steps, various steps in FIG. 17 could overlap, occur in parallel, occur in a different order, or occur any number of times.

In one example (example 2 in FIG. 17), the cell switch time (delay) may be from the message from the UE indicating or requesting or triggering or initiating handover (this may be on PUCCH or PUSCH (UCI or MAC CE) as aforementioned). The cell switch time may be from the end of the message (Example 2 of FIG. 17) or from the start of the message. In another example (example 1 in FIG. 17), the cell switch time (delay) may be from the acknowledgement of UE message indicating or requesting or triggering or initiating handover. The cell switch time may be from the end of the ACK message (Example 1 of FIG. 17) or from the start of the ACK message. In one example, the ACK message may be a DCI format on PDCCH that the network sends in response to the message from the UE (e.g., measurement report). In another example, the ACK message may be a DL transmission (e.g., PDCCH+PDSCH or MAC CE) that the network sends in response to the message from the UE.

At step 1690 of FIG. 16 information is exchanged between source cell 1601 target (or candidate) cell 1602 to complete the handover at the cell switch time.

Although FIG. 16 illustrates one example of a method 1600 of handover based on UE initiation, various changes may be made to FIG. 16. For example, while shown as a series of steps, various steps in FIG. 16 could overlap, occur in parallel, occur in a different order, or occur any number of times.

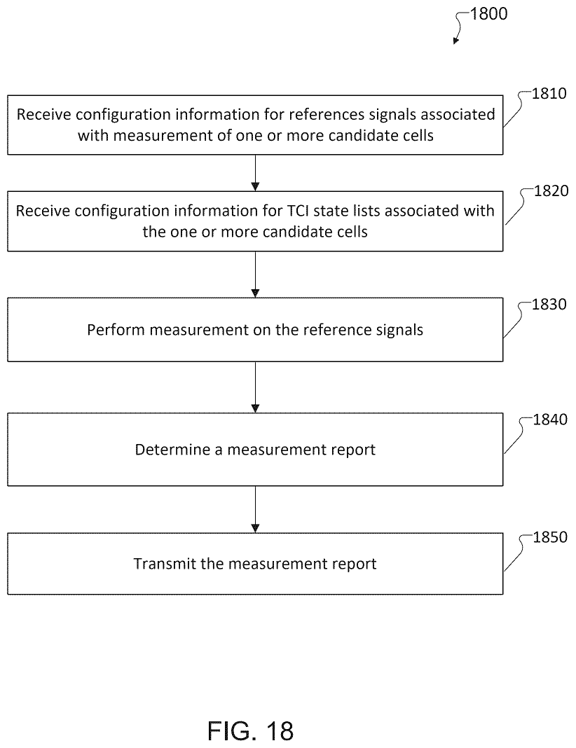

FIG. 18 illustrates an example method 1800 of a UE initiated cell switch according to embodiments of the present disclosure. An embodiment of the method illustrated in FIG. 18 is for illustration only. One or more of the components illustrated in FIG. 18 may be implemented in specialized circuitry configured to perform the noted functions or one or more of the components may be implemented by one or more processors executing instructions to perform the noted functions. Other embodiments of a UE initiated cell switch could be used without departing from the scope of this disclosure.

As illustrated in FIG. 18, the method 1800 begins at step 1810. At step 1810, a UE receives configuration information for reference signals associated with measurement of one or more candidate cells. At step 1820, the UE receives configuration information for transmission configuration indicator (TCI) state lists associated with the one or more candidate cells. At step 1830, the UE performs measurement on the reference signals. At step 1840, the UE determines, based on the measurement, a measurement report.

At step 1850, the UE transmits the measurement report. In one embodiment, the measurement report may include L×M measurements. L may refer to a number of cells included in the measurement report. M may refer to a number of measurements reported for each cell of the number of cells in the measurement report. In another embodiment, the measurement report may include reference signal ID and a corresponding measured L1-reference signal received power (L1-RSRP). In yet another embodiment, the measurement report is included in uplink control information (UCI), transmitted on a physical uplink control channel (PUCCH) or a physical uplink shared channel (PUSCH).

Although FIG. 18 illustrates one example of a method 1800 of a UE initiated cell switch, various changes may be made to FIG. 18. For example, while shown as a series of steps, various steps in FIG. 18 could overlap, occur in parallel, occur in a different order, or occur any number of times.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle.

What is claimed is:

1. A user equipment (UE) comprising:
a processor and;
a transceiver operably coupled with the processor, the transceiver configured to:
receive transmission configuration indication (TCI) state lists for candidate cells for layer-1/layer-2 (L1/L2) mobility, wherein the TCI state lists respectively include (i) joint TCI states for downlink and uplink or (ii) separate TCI states for downlink or uplink;
receive a first medium access control control element (MAC CE) activating TCI states in a TCI state list for a candidate cell;
receive a second MAC CE triggering the L1/L2 mobility to the candidate cell, wherein the second MAC CE indicates a TCI state among the activated TCI states; and
perform communication on the candidate cell based on the indicated TCI state,
wherein the indicated TCI state includes a pathloss reference signal identity for the candidate cell and uplink power control identity for the candidate cell, where the indicated TCI state is (i) joint TCI state for downlink and uplink or (ii) separate TCI state for uplink, and
wherein the indicated TCI state is associated with a synchronization signal/physical broadcast channel (SS/PBCH) block of the candidate cell or a channel state information reference signal (CSI-RS) resource of the candidate cell.

2. The UE of claim 1, wherein the transceiver is further configured to:
receive configuration information for at least one reference signal associated with the candidate cell; and
after receiving the second MAC CE, transmit, to the candidate cell using a configured grant or using a type 1 or type 2 random access procedure, a first measurement report obtained based on the at least one reference signal associated with the candidate cell,
wherein the transmission of the first measurement report is initiated by the UE.

3. The UE of claim 1, wherein:
the transceiver is further configured to receive configuration information for reference signals associated with the candidate cells, configuration information associated with a first number, and configuration information associated with a second number;
the processor is configured to determine a second measurement report based on the reference signals associated with the candidate cells; and
the transceiver is further configured to transmit the second measurement report,
wherein the second measurement report includes, for each of the first number of cells, the second number of reference signal indicators, and the second number of layer 1-reference signal received powers (L1-RSRPs), and
wherein the first number of cells include (i) a number of candidate cells among the candidate cells or (ii) a number of candidate cells among the candidate cells and a source cell associated with the L1/L2 mobility.

4. The UE of claim 3, wherein the second measurement report is configured with one of periodic, semi-persistent, or aperiodic,
wherein the references signals are SS/PBCH blocks or CSI-RSs, and
wherein remaining L1-RSRPs except for a first L1-RSRP among the L1-RSRPs are differential L1-RSRPs relative to the first L1-RSRP.

5. A method of operating a user equipment (UE), the method comprising:
receiving transmission configuration indication (TCI) state lists for candidate cells for layer-1/layer-2 (L1/L2) mobility, wherein the TCI state lists respectively include (i) joint TCI states for downlink and uplink or (ii) separate TCI states for downlink or uplink;
receiving a first medium access control control element (MAC CE) activating TCI states in a TCI state list for a candidate cell;
receiving a second MAC CE triggering the L1/L2 mobility to the candidate cell, wherein the second MAC CE indicates a TCI state among the activated TCI states; and
performing communication on the candidate cell based on the indicated TCI state,
wherein the indicated TCI state includes a pathloss reference signal identity for the candidate cell and uplink power control identity for the candidate cell, where the indicated TCI state is (i) joint TCI state for downlink and uplink or (ii) separate TCI state for uplink, and
wherein the indicated TCI state is associated with a synchronization signal/physical broadcast channel (SS/PBCH) block of the candidate cell or a channel state information reference signal (CSI-RS) resource of the candidate cell.

6. The method of claim 5, further comprising:
receiving configuration information for at least one reference signal associated with the candidate cell; and
after receiving the second MAC CE, transmitting, to the candidate cell using a configured grant or using a type 1 or type 2 random access procedure, a first measurement report obtained based on the at least one reference signal associated with the candidate cell,
wherein the transmission of the first measurement report is initiated by the UE.

7. The method of claim 5, further comprising:
receiving configuration information for reference signals associated with the candidate cells, configuration information associated with a first number, and configuration information associated with a second number;
determining a second measurement report based on the reference signals associated with the candidate cells; and
transmitting the second measurement report,
wherein the second measurement report include, for each of the first number of cells, the second number of reference signal indicators, and the second number of layer 1-reference signal received powers (L1-RSRPs), and
wherein the first number of cells include (i) a number of candidate cells among the candidate cells or (ii) a number of candidate cells among the candidate cells and a source cell associated with the L1/L2 mobility.

8. The method of claim 7, wherein the second measurement report is configured with one of periodic, semi-persistent, or aperiodic,
wherein the references signals are SS/PBCH blocks or CSI-RSs, and
wherein remaining L1-RSRPs except for a first L1-RSRP among the L1-RSRPs are differential L1-RSRPs relative to the first L1-RSRP.

9. A base station (BS) comprising:
a processor; and
a transceiver operably coupled with the processor, the transceiver configured to:
transmit transmission configuration indication (TCI) state lists for candidate cells for layer-1/layer-2 (L1/L2) mobility, wherein the TCI state lists respectively include (i) joint TCI states for downlink and uplink or (ii) separate TCI states for downlink or uplink;
transmit a first medium access control control element (MAC CE) activating TCI states in a TCI state list for a candidate cell;
transmit a second MAC CE triggering the L1/L2 mobility to the candidate cell, wherein the second MAC CE indicates a TCI state among the activated TCI states; and
perform communication on the candidate cell associated with the indicated TCI state,
wherein the indicated TCI state includes a pathloss reference signal identity for the candidate cell and uplink power control identity for the candidate cell, where the indicated TCI state is (i) joint TCI state for downlink and uplink or (ii) separate TCI state for uplink, and
wherein the indicated TCI state is associated with a synchronization signal/physical broadcast channel (SS/PBCH) block of the candidate cell or a channel state information reference signal (CSI-RS) resource of the candidate cell.

10. The BS of claim 9, wherein the transceiver is further configured to:
transmit configuration information for at least one reference signal associated with the candidate cell; and
after transmitting the second MAC CE, receive, on the candidate cell based on a configured grant or using a type 1 or type 2 random access procedure, a first measurement report associated with the at least one reference signal associated with the candidate cell.

11. The BS of claim 9, wherein the transceiver is further configured to:
transmit configuration information for reference signals associated with the candidate cells, configuration information associated with a first number, and configuration information associated with a second number; and
receive a second measurement report,
wherein the second measurement report includes, for each of the first number of cells, the second number of reference signal indicators, and the second number of layer 1-reference signal received powers (L1-RSRPs), and
wherein the first number of cells include (i) a number of candidate cells among the candidate cells or (ii) a number of candidate cells among the candidate cells and a source cell associated with the L1/L2 mobility.

12. The BS of claim 11, wherein the second measurement report is configured with one of periodic, semi-persistent, or aperiodic,
wherein the references signals are SS/PBCH blocks or CSI-RSs, and
wherein remaining L1-RSRPs except for a first L1-RSRP among the L1-RSRPs are differential L1-RSRPs relative to the first L1-RSRP.
